(19) United States
(12) Patent Application Publication
(10) Pub. No.: US 2026/0086603 A1
(43) Pub. Date: Mar. 26, 2026

(54) Head-Mounted Devices with Adjustable Headbands

(71) Applicant: Apple Inc., Cupertino, CA (US)

(72) Inventors: Andrew Gallaher, Sammamish, WA (US); Jackson C Masters, Newark, CA (US); Erin N Mieth, San Francisco, CA (US); Glenn K Trainer, Kirkland, WA (US); Zilan Chen, Shenzhen (CN); Nicholas R Trincia, San Francisco, CA (US); Linda D Benavente-Notaro, Menlo Park, CA (US); Claire E Dalke, Belmont, CA (US); Matthew A Mayer, Los Gatos, CA (US); Thuan D Doan, Sunnyvale, CA (US); Samuel G Smith, San Francisco, CA (US); Jonathan M Lee, Millbrae, CA (US)

(21) Appl. No.: 19/337,606

(22) Filed: Sep. 23, 2025

Related U.S. Application Data
(60) Provisional application No. 63/699,076, filed on Sep. 25, 2024.

(51) Int. Cl. G06F 1/16; F16C 1/12; F16H 19/02; F16H 19/04; F16M 13/04

(52) U.S. Cl. CPC G06F 1/163; F16C 1/12; F16H 19/02; F16H 19/04; F16M 13/04

(57) ABSTRACT

A head-mounted device may include optical assemblies in a head-mounted housing for presenting images to a user. The head-mounted device housing may be supported at the front of the head of a user in front of the user's eyes using a headband system that includes one or more headband portions. The headband portions may be tightened or loosened to adjust the fitment of the headband system. To ensure that multiple portions of a single headband portion are adjusted by the same amount, an adjuster that moves the multiple portions symmetrically may be used. The headband system may be attached to the head-mounted device at a post with one or more latches. One or more removable components, such as a removable battery and/or weight, may be attached to one of the headband portions. The headband portions may include telescoping tubes, or may include multiple portions separated by an expandable extension.

This application claims the benefit of U.S. provisional Ser. No. 63/699,076, filed Sep. 25, 2024, which is hereby incorporated by reference herein in its entirety.

### FIELD

This relates generally to headbands for electronic devices, including headbands for head-mounted devices.

### BACKGROUND

Electronic devices have components such as displays and lenses. Headbands and/or straps may be used to help hold electronic devices such as head-mounted devices on the heads of users.

### SUMMARY

A head-mounted device may include optical assemblies for presenting images to a user. Each optical assembly may have a display and a lens. The optical assemblies may be mounted in a head-mounted device housing. Additional components such as sensors, input-output devices, fans, optical assembly positioning systems, and other components may be mounted in the housing.

The head-mounted device may be worn on the user's head using a headband system. The headband system may include one or more headbands having headband portions. For example, the headband system may include a rear headband portion and an upper headband portion.

The headband portions may be tightened or loosened to adjust the fitment of the headband system on the user's head. To ensure that multiple portions of a single headband portion are adjusted by the same amount, an adjuster that moves the multiple portions symmetrically may be included in the headband portion. The adjuster may be a symmetric telescoping dial, a turnbuckle, spur gears and lead screws, or a rack and pinion system, as examples. The adjuster may be moved by a dial attached to a cable, one or more motors, or another suitable input.

The headband system may be attached to the head-mounted device at a post. The headband system may include one or more latches that lock the headband system onto the post.

One or more removable components, such as a removable battery and/or a removable weight, may be attached to one of the headband portions of the headband system. For example, a removable battery may charge the head-mounted device or a built-in battery in the headband system. A weight may provide a counterbalance to the mass of the head-mounted device.

The headband portions may include telescoping tubes. The telescoping tubes may extend across a rear portion of the user's head and/or the top of the user's head. The lengths of the telescoping tubes may be adjusted to adjust the tension of the headband portions. Pads may cover the telescoping tubes.

The headband portions may include multiple portions separated by an expandable extension. The expandable extension may expand based on a size of the user's head when the headband system is worn.

The headband portions may include one or more cantilevers formed from sliding weights in a channel in the headband portions. The cantilevers may counterbalance the mass of the head-mounted device to ensure a comfortable fit.

The headband portions may include one or more molded portions, such as lattice structures and/or molded elliptical structures, which may be ribbed to increase their flexibility. Alternatively or additionally, the headband portions may include accordion folds, which may increase flexibility of the headband portions and/or may be used to house weighted components and/or removable batteries.

A rear headband portion may include a first strap and a second strap coupled to the head-mounted device. A structure may be interposed between the first strap and the second strap and may house ends of the first and second straps. The structure may include ribs coupled to a spine, adjustment cables that extend from the first strap to the second strap through the structure, and elastic between the first and second straps.

### BRIEF DESCRIPTION OF THE DRAWINGS

FIG. 1 is a perspective view of an illustrative head-mounted device coupled to a head of a user with a headband system in accordance with some embodiments.

FIG. 2A is a front view of a headband portion that includes multiple portions separated by a support in accordance with some embodiments.

FIG. 2B is a front view of a headband portion that includes multiple portions separated by a support and adjustable using a cable in accordance with some embodiments.

FIG. 3 is a front view of an illustrative headband portion including multiple portions that are symmetrically adjustable using a symmetric telescoping cable in accordance with some embodiments.

FIG. 4 is a front view of an illustrative headband portion including a symmetric telescoping cable and a spring for removal while maintaining the tension of the headband portion in accordance with some embodiments.

FIG. 5 is a front view of an illustrative headband portion including a symmetric telescoping cable and springs that bias multiple portions of the headband portion toward one another in accordance with some embodiments.

FIG. 6A is a front view of an illustrative headband portion including a symmetric telescoping cable that is adjusted using motors in accordance with some embodiments.

FIG. 6B is a front view of an illustrative motor that may be used to adjust a symmetric telescoping cable in accordance with some embodiments.

FIG. 7 is a side view of an illustrative head-mounted device coupled to a head with a headband system that allows for release of the tension of the headband system in accordance with some embodiments.

FIG. 8A is a front view of an illustrative headband portion including multiple portions that are symmetrically adjustable using a turnbuckle in accordance with some embodiments.

FIG. 8B is a side view of an illustrative turnbuckle in accordance with some embodiments.

FIG. 9A is a front view of an illustrative headband portion including multiple portions that are symmetrically adjustable using spur gears and lead screws in accordance with some embodiments.

FIG. 9B is a front view of an illustrative set of spur gears and lead screws in accordance with some embodiments.

FIG. 10 is a front view of an illustrative headband portion including multiple portions that are symmetrically adjustable using a rack and pinion system in accordance with some embodiments.

FIG. 11A is a perspective view of a headband system including headband portions with multiple telescoping tubes in accordance with some embodiments.

FIG. 11B is a side view of an illustrative telescoping tube in accordance with some embodiments.

FIG. 11C is a perspective view of an illustrative pad that includes openings through which telescoping tubes are routed in accordance with some embodiments.

FIG. 11D is a perspective view of an illustrative pad that includes openings through which telescoping tubes are routed and a removable component that may be attached to the pad in accordance with some embodiments.

FIG. 12 is a perspective view of an illustrative headband system including multiple telescoping tubes in accordance with some embodiments.

FIG. 13 is a side view of an illustrative enclosure that includes a battery and openings through which telescoping tubes are routed in accordance with some embodiments.

FIG. 14A is a front view of an illustrative headband portion including multiple portions that are adjustable along a friction channel in accordance with some embodiments.

FIG. 14B is a side view of an illustrative friction channel in accordance with some embodiments.

FIG. 15 is a side view of an illustrative latch in a headband portion that engages a recess in a post in a head-mounted device to lock the headband portion to the head-mounted device in accordance with some embodiments.

FIG. 16 is a side view of an illustrative latch in a headband portion that clamps a post in a head-mounted device to lock the headband portion to the head-mounted device in accordance with some embodiments.

FIGS. 17A and 17B are top views of illustrative headband systems that include adjustable counterweights in accordance with some embodiments.

FIG. 18A is a top view of an illustrative headband system that includes a component that separates two portions of a headband and that includes one or more removable components attached to the component in accordance with some embodiments.

FIGS. 18B and 18C are cross-sectional views of illustrative removable weights that may be attached to a headband portion in accordance with some embodiments.

FIG. 19 is a top view of an illustrative headband system that includes a removable battery attached to a built-in battery in accordance with some embodiments.

FIG. 20 is a perspective view of an illustrative headband system that includes multiple separated portions bridged by extensions to accommodate different head sizes in accordance with some embodiments.

FIG. 21 is a perspective view of an illustrative headband system that includes a headband portion with a stretchable portion that allows the headband system to be removed while maintaining the tension of the headband system in accordance with some embodiments.

FIG. 22 is a side view of an illustrative headband system that includes a cantilevered headband portion and a front headband portion in accordance with some embodiments.

FIG. 23 is a side view of an illustrative headband system that includes a cantilevered headband portion in accordance with some embodiments.

FIG. 24A is a side view of an illustrative headband system that includes headband portions with lattice structures in accordance with some embodiments.

FIG. 24B is a side view of an illustrative headband system that includes a headband portion with molded elliptical structures in accordance with some embodiments.

FIG. 24C is a side view of an illustrative headband portion having ribbed structures in accordance with some embodiments.

FIG. 24D is a top view of an illustrative headband portion that is double backed on and magnetically attached to itself in accordance with some embodiments.

FIG. 25A is a perspective view of an illustrative headband system that includes headband portions with accordion folds in accordance with some embodiments.

FIG. 25B is a top view of an illustrative headband portion with a cable that is offset relative to the center of an accordion fold in accordance with some embodiments.

FIG. 26 is a side view of an illustrative headband portion formed from removable links in accordance with some embodiments.

FIGS. 27A and 27B are views of an illustrative headband system with a headband portion that telescopes and stows in accordance with some embodiments.

FIGS. 28A and 28B are views of an illustrative headband system with a headband portion that includes vertical ribs and an adjustment cable that extends through the vertical ribs in accordance with some embodiments.

### DETAILED DESCRIPTION

Head-mounted devices may have housings that are supported on a user's head using support structures such as headbands (e.g., a headband system). A head-mounted device may have a housing that rests against the front of a user's head in alignment with the user's eyes during use. This allows displays in the housing to present images to the user.

One or more headbands of the headband system may be adjustable. For example, the headband(s) may be tightened or loosened to adjust the headband system to fit the user's head and/or to remove the headband system from the head. Some headbands may use fasteners, such as hook and loop fasteners, to secure the headbands once they are adjusted.

In some circumstances, it may be desirable to incorporate an adjustment the tightens and/or loosens opposing ends of a headband by the same amount in response to a single adjustment (e.g., tightening and loosening a dial), allowing for easier adjustments and better fit. For example, symmetric telescoping may be incorporated into the headband to allow for symmetric adjustments. The symmetric telescoping may be adjusted using a dial, by directly pushing/pulling on the headbands, or using motors, as examples. The symmetric telescoping may be implemented using a cable wound through the headband, a turnbuckle or gear interface, or a rack and pinion system, as examples.

Alternatively or additionally, the headbands may include multiple tubes that extend over and/or behind a user's head when worn. The tubes may be telescoping to adjust the fit of the headbands. As another example, a friction channel may be used for headband adjustments.

The headbands may be attached to the head-mounted device housing at a post. A latch may be incorporated to secure the headband to the latch.

In addition to adjusting the tightness of the headband, the headband may be counterbalanced with one or more weights. The weights may be movable toward and away from a user's head and/or may be removable to allow for adjustments of the counterbalance weight.

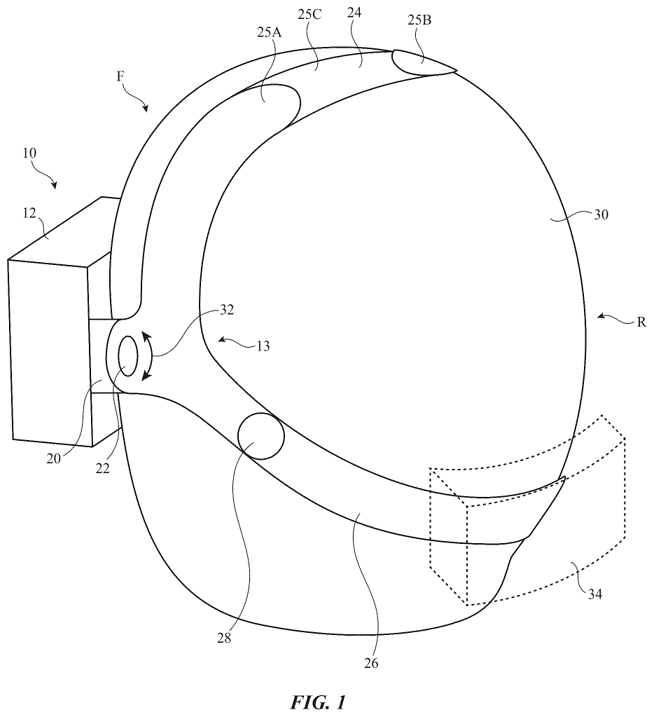

A perspective view of an illustrative head-mounted device with an adjustable headband system is shown in FIG. 1. As shown in FIG. 1, head-mounted device 10 (also referred to as device 10 herein) may have a housing such as housing 12 (also referred to as head-mounted housing 12 herein). Housing 12 may be worn on front F of a user's head such as head 30. Headband system 13 may be used to help hold housing 12 in place on head 30. In the illustrative example of FIG. 1, headband system 13 includes upper headband portion 24 and lower headband portion 26 at rear R of head 30. In general, however, headband system 13 may have one or more headbands and/or straps that hold housing 12 in place on head 30. Headband portions 24 and 26 may be formed from straps, such as adjustable straps, that maintain sufficient friction/tightness on head 30 to hold housing 12 in place on head 30. In the example of FIG. 1, headband portions 24 and 26 are integrated into a single headband. However, this is merely illustrative. In some embodiments, separate upper and lower headbands may be used in headband system 13.

Housing 12 may contain a forward-facing display (e.g., a three-dimensional display having lenticular lenses overlapping an array of display pixels, or a two-dimensional display) that faces away from the face of the user when worn, sensors such as forward facing cameras, and other components (e.g., control circuitry such as microprocessor circuitry, storage, application-specific integrated circuits, sensors, speakers, an optional battery, etc.). Left and right optical assemblies (sometimes referred to as optical modules) may be used to display images in eye boxes. When a user's eyes are located in the eye boxes, left and right displays and corresponding left and right lenses in the optical assemblies may present images to the user (e.g., computer generated images, real-life images captured with cameras, and/or other content).

Head-mounted housing 12 may have stiff portions (e.g., a polymer shell, a glass cover layer over the display, metal frame structures, and stiff structures formed from combinations of polymer, ceramic, glass, metal, and/or other stiff materials). These stiff portions may include elongated stiff housing extensions such as extension 20 (sometimes referred to as a power strap, elongated stiff housing portion, stiff strip-shaped extension, stiff extension, stiff strip, or stiff strap portion). In some embodiments, extension 20 and/or other stiff portions of head-mounted housing 12 may be rigid. Alternatively, one or more of extension 20 and/or other stiff portions of head-mounted housing 12 may exhibit a small amount of flexibility, or have flexible portions, while remaining stiff.

Extension 20 may be attached to and/or integrated with the body of housing 12 at front F of head 30 and may extend rearwardly toward or past the ears of the user when device 10 is worn towards connection 22 (also referred to as post 22 herein). In some embodiments, extension 20 may be fixedly attached to the body of housing 12 (e.g.., extension 20 may not move and/or rotate relative to housing 12). However, this is merely illustrative. If desired, extension 20 may move (e.g., extend and retract) and/or rotate relative to housing 12 while being attached to housing 12.

Connection 22 may, if desired, have a first part that is fixedly attached to extension 20 and a second part that is carried on removable items such as headbands. Headbands may be attached to extension 20 at connection 22 and/or elsewhere along the length of extension 20. For example, connection 22 may include a post that engages with openings in one or more headbands of headband system 13. One or more latches or other mechanisms may be used to attach the headbands to the post. However, this is merely illustrative. In general, connection 22 may include any suitable connector(s).

In the example of FIG. 1, system 13 has an upper headband portion such as headband portion 24. Headband portion 24 may have a narrow strip shape or a wider shape that extends over most or all of the top of head 30 from one side of head 30 to an opposing side of head 30. Headband portion 24 (and headband portion 26) may be removably attached to extension 20 at connection 22. During use of device 10, headband portion 24 may help bear some of the weight of device 10 on the upper portion of head 30. Headband portion 24 may be formed from a stretchy material (e.g., stretchable fabric and/or elastic materials) and/or may be partly or entirely formed from stiff materials (e.g., plastic, metal, and/or other stiff materials), such as at least partially rigid materials, stiffeners embedded in fabric, flexible materials (e.g., elastomer), and/or other materials.

System 13 may, if desired, have a lower headband portion such as headband portion 26. Headband portion 26, which may sometimes be referred to as a lower rear headband portion, may be formed from a stretchy material (e.g., stretchable fabric and/or elastic materials) and/or may be partly or entirely formed from stiff materials (e.g., plastic, metal, and/or other stiff materials), such as at least partially rigid materials, stiffeners embedded in fabric, flexible materials (e.g., elastomer), and/or other materials. During use of device 10, headband 26 may hug the lower portion of rear R of head 30 to help hold device 10 on head 30.

One or more headband portions of headband system 13 may be adjustable. For example, in the example of FIG. 1, headband portion 24 and/or headband portion 26 may be loosened or tightened to fit headband system 13 to head 30. In particular, headband portion 24 may have adjustment portions 25A and 25B attached to central portion 25C. Adjustment portions 25A and 25B may be removably attached to central portion 25C, such as using hook and loop fasteners, snaps, buttons, magnets, and/or other suitable attachment(s). By moving adjustment portions 25A and 25B closer to one another, headband portion 24 may be tightened on the top of head 30. Moving adjustment portions 25A and 25B further from one another, headband portion 24 may be loosened.

Headband portion 26 may be loosened/tightened using dial 28. Dial 28 may be rotated, which may in turn loosen or tighten headband portion 26, such as using one or more cables in headband portion 26, using a rack and pinion system, and/or other suitable adjusters. Although not shown in FIG. 1, dial 28 may also be used to adjust headband portion 24, if desired.

Although headband portions 24 and 26 are shown as forming a single headband attached to connection 22 in the example of FIG. 1, this is merely illustrative. In some embodiments, headband portions 24 and 26 form separate headbands that are each attached to connection 22 (or each attached to a respective connection/post). In general, headband system 13 may include any suitable number of headbands and/or headband portions.

Regardless of the number of headbands in headband system 13, one or more headband portions of headband system 13 may move relative to connection 22 when headband system 13 is attached to connection 22. For example, there may be play between headband system 13 and connection 22, allowing headband system 13 to rotate in directions 32 by at least 0.5°, at least 1°, between 1° and 3°, less than 3.5°, or another suitable amount. This may allow for improved comfort when headband system 13 and device 10 are worn on head 30. However, this is merely illustrative. In some embodiments, there may be no play between headband system 13 and connection 22.

Alternatively or additionally, optional component 34 may be added to headband portion 26. Optional component 34 may include a battery, which may be electrically connected to device 10 to provide power to device 10 (e.g., over a wired or wireless connection). The battery may be fixedly attached to headband portion 26, or the battery may be removably attached to headband portion 26. Alternatively or additionally, optional component 34 may include a removable counterweight (e.g., a removable weighted component), such as a polymer or metal counterweight, a textile (or other material) filled with metal or polymer weighted pellets, or another suitable counterweight. The counterweight may balance the weight of device 10 to reduce the pressure applied to the face of the user.

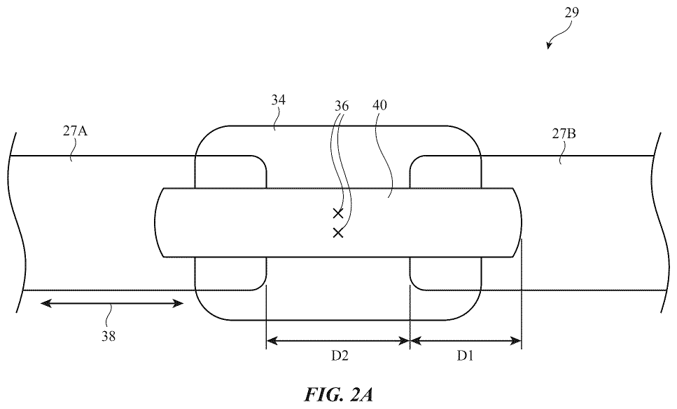

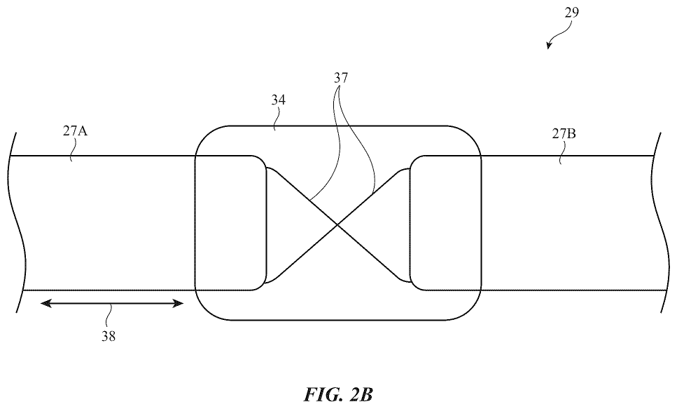

In some embodiments, such as when one or more optional components 34 are incorporated on headband portion 26, it may be desirable to increase the moment resistance of headband portion 26 (e.g., increase the resistance of headband potion 26 of rotating due to components 34). Therefore, a support may be incorporated in headband portion 26. An illustrative example is shown in FIG. 2A.

As shown in FIG. 2A, headband portion 29 may include headband portions 27A and 27B. Headband portion 29 may correspond with headband portion 24 or headband portion 26 of FIG. 1, or another suitable headband portion of system 13. Headband portions 27A and 27B may be formed from, for example, fabric portions with embedded stiffeners, such as embedded polymers; elastomer; polymer; and/or other suitable material(s). In some embodiments, headband portions 27A and 27B may include thermoplastic polyurethane (TPU) or another suitable polymer.

Headband portion 29 may also include support 40 between portions 27A and 27B. Support 40 may be formed from elastomer, polytetrafluoroethylene (PTFE), metal (e.g., sheet metal), or another suitable material. Support 40 may be fastened to component 34 at fasteners 36. For example, support 40 may be attached to component 34 using one or more adhesives, welds, magnets, snaps, and/or other attachments. Alternatively, component 34 may be omitted.

Headband portions 27A and 27B may be coupled to support 40 and may move slidably relative to support 40. For example, support 40 may slide within an opening (e.g., a cavity) within headband portions 27A and 27B in directions 38. By sliding headband portions 27A and 27B closer together, headband portion 26 may be tightened. By sliding headband portions 27A and 27B further apart, headband portion 26 may be loosened. In this way, headband portion 29 may be adjusted.

Support 40 may have minimum overlap of distance D1 with portions 27A and 27B when portions 27A and 27B are at maximum extension (e.g., furthest apart). For example, the length of support 40 between the ends of portions 27A and 27B when portions 27A and 27B are at maximum extension may be distance D2. A ratio of distance D2 to distance D1 may be 2:1 or less, 3:1 or less, or another suitable ratio. By ensuring that support 40 has sufficient overlap (distance D1) with portions 27A and 27B, headband portion 29 may have increased moment resistance.

In some embodiments, a cable may be incorporated within headband portion 29 to adjust the distance between headband portions 27A and 27B. An illustrative example is shown in FIG. 2B.

As shown in FIG. 2B, headband portion 29 may include support portion 35 between headband portions 27A and 27B. Support portion 35 may house cable 37 that extends between headband portions 27A and 27B. Cable 37 may be tightened and loosened to move headband portions 27A and 27B in directions 38 (e.g., to tighten and loosen headband portion 29). For example, cable 37 may be attached to a dial that is turned by a user to tighten and loosen headband portion 29. Alternatively, cable 37 may be pulled by the user directly or may otherwise be tightened and loosened to tighten and loosen headband portion 29.

Although FIG. 2B shows cable 37 between headband portions 27A and 27B, this is merely illustrative. In general, any suitable mechanism may be incorporated between headband portions 27A and 27B to tighten and loosen headband portion 29. For example, headband portions 27A and 27B may be coupled to tracks or shafts within support portion 35, and one or more dials may move headband portions 27A and 27B along the tracks or shafts to tighten and loosen headband portion 29.

Although not shown in FIG. 2B, a component, such as a battery (e.g., component 34 of FIG. 2A) may be attached to support portion 35, such as using magnets, clips, press-fit components, and/or any other suitable attachments.

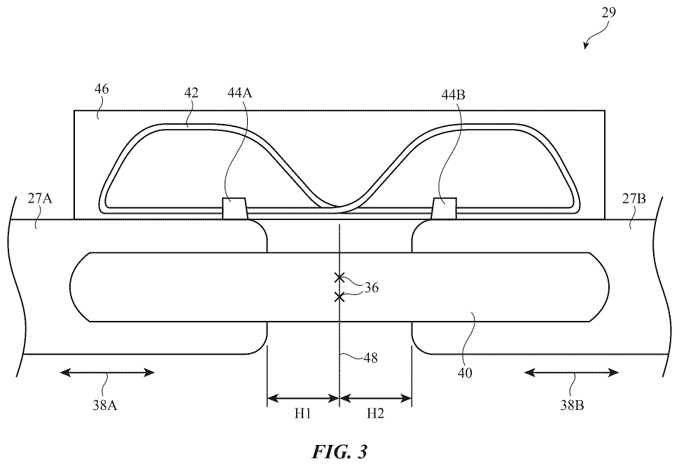

In addition to, or instead of, maintaining a minimum overlapping distance between support 40 and portions 27, symmetric telescoping may be incorporated into a headband to ensure that multiple portions of a headband extend/retract by the same amount when the headband is loosened/tightened. An illustrative example is shown in FIG. 3.

As shown in FIG. 3, a headband, such as headband portion 29, may include symmetric telescoping cable 42 attached to portions 27A and 27B. Cable 42 may be formed from metal, polymer, and/or other suitable material.

In the example of FIG. 3, portion 27A may have extension 44A and portion 27B may have extension 44B. Symmetric telescoping cable 42 may be routed through extension 44A and extension 44B. Symmetric telescoping cable 42 may also be routed through enclosure 46. Enclosure 46 may also enclose component(s) 34 (FIG. 2A) or may be a dedicated enclosure for cable 42.

Cable 42 may be routed in a figure-eight configuration within enclosure 46. Therefore, when portion 27A is moved by a distance in directions 38A, portion 27B may move by the same distance in directions 38B symmetrically (e.g., opposite) to the movement of portion 27A. Similarly, when portion 27B is moved by a distance in directions 38B, portion 27A may move by the same distance in directions 38A symmetrically (e.g., opposite) to the movement of portion 27B. In other words, distance H1 between center 48 of support 40 and portion 27A may be equivalent to distance H2 between center 48 and portion 27B regardless of the adjustments made to portion 27A and/or portion 27B. In this way, by adjusting one of portion 27A or portion 27B, such as by directly moving portion 27A or 27B, turning a dial to move portion 27A or portion 27B, or otherwise moving portion 27A or 27B, the other portion (27A or 27B) of headband portion 29 may be automatically adjusted by the same amount by symmetric telescoping cable 42.

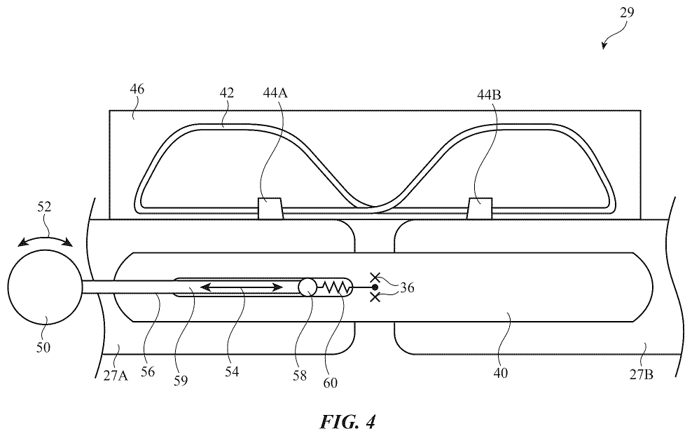

For example, in some embodiments, a dial may be used to adjust portion 27A, and portion 27B may be adjusted by the same amount by symmetric telescoping cable 42. A spring may be incorporated in portion 27A to allow removal of headband system 13 and device 10 (FIG. 1) while maintaining the tightness of headband portion 29. An illustrative example is shown in FIG. 4

As shown in FIG. 4, in addition to headband portion 29 including symmetric telescoping cable 42, headband portion 29 may include dial 50 (also referred to as adjustment dial 50 herein) to adjust a tension of headband portion 29. In particular, dial 50 may be coupled to tension cable 56 that in turn is wrapped around pulley (or other suitable mechanism) 58. Pulley 58 may be formed in pulley track 59 in support 40 and/or portion 27A.

By turning adjustment dial 50 in directions 52, pulley 58 may be moved in directions 54 along pulley track 59, thereby moving portion 27A in directions 54. Symmetric telescoping cable 42 may moving portion 27B symmetrically by the same amount, ensuring that the distances between portions 27A and 27B relative to a center of support 40 remains constant. In this way, the tension of headband portion 29 may be adjusted (e.g., headband portion 29 may be loosened/tightened) by rotating dial 50.

Portion 27A may also include spring 60 between pulley 58 and a support 40. In other words, spring 60 may be attached to pulley 58 and support 40. When a user removes headband system 13 and device 10 (FIG. 1) from their head, spring 60 may expand, allowing the headband and device to be removed. When the headband and device are returned to the head, headband portion 29 may have the same tension (e.g., tightness/looseness), as spring 60 will return to its original position prior to being removed from the head.

Although FIG. 4 shows spring 60 between pulley 58 and support 40, this is merely illustrative. In general, any suitable stretchable material, such as an elastomer, may be coupled to pulley 58 and support 40 to maintain the tension of headband portion 29 when it is removed and returned to a user's head.

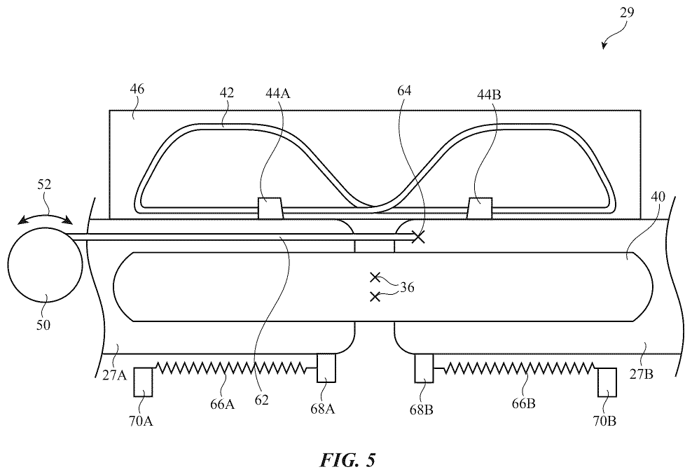

Instead of, or in addition to, including a return force spring, such as spring 60, in headband portion 29, additional spring(s) may be incorporated into headband portion 29 to bias portions 27A and 27B toward one another. An illustrative example is shown in FIG. 5.

As shown in FIG. 5, springs 66A and 66B may be included in portions 27A and 27B, respectively. Springs 66A and 66B may be springs that are biased open (e.g., extended) and may be coupled between extensions 68A and 68B of portions 27A and 27B and supports 70A and 70B. In other words, springs 66A and 66B may bias portions 27A and 27B towards one another. Supports 70A and 70B may be a portion of enclosure 46, as an example.

Cable 62 may be coupled between dial 50 (in portion 27A) and portion 27B. In operation, springs 66A and 66B may bias portions 27A and 27B toward one another. Dial 50 may be rotated in direction 52 to move portion 27B. Due to symmetric telescoping cable 42, portion 27A may move symmetrically to portion 27B (e.g., by the same amount as, and in an opposite direction to, the movement of portion 27B). Therefore, the tension of headband portion 29 may be adjusted by rotating dial 50.

Although springs 66A and 66B are shown along bottom edges of portions 27A and 27B, this is merely illustrative. In general, springs 66A and 66B may be coupled to portions 27A and 27B in any suitable locations, such as along the top and/or bottom edges of portions 27A and 27B.

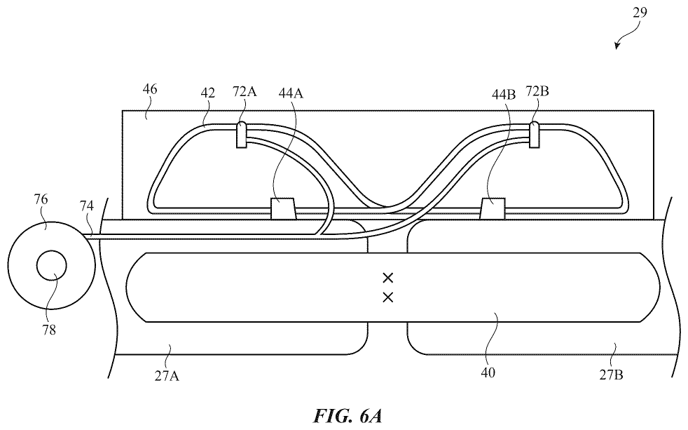

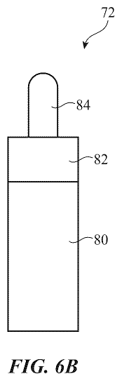

Instead of using a dial to pull a cable and adjust the tension of headband portion 29, one or more motors may be used to adjust the tension of headband portion 29. An illustrative example is shown in FIG. 6A.

As shown in FIG. 6A, headband portion 29 may include motors 72A and 72B in enclosure 46. As shown in FIG. 6B, motors 72A and 72B may each include motor 80 coupled to a clutch, brake, and encoder assembly 82. Assembly 82 may be coupled to winch pulley 84.

Each winch pulley 84 may be coupled to symmetric telescoping cable 42, as shown in FIG. 6A. Motors 72A and 72B may be coupled to interconnect 74, which in turn may be coupled to haptic dial 76. Haptic dial 76 may include dial encoder 78.

In operation, haptic dial 76 may be rotated, and dial encoder 78 may send signals over interconnect 74 to motors 72A and 72B. In response to these signals, motors 72A and 72B may move cable 42, which in turn may move portions 27A and 27B, adjusting the tension of headband portion 29. In this way, motors 72A and 72B may be used to adjust the tension of headband portion 29.

Although haptic dial 76 is shown as providing input to motors 72A and 72B, this is merely illustrative. In general, any suitable input, such as one or more buttons, one or more sliders, one or more switches, or voice input to a speaker, as examples, may be used to activate motors 72A and 72B to move cable 42 and adjust the tension of headband portion 29.

Moreover, although motors 72A and 72B are shown as adjusting cable 42, this is merely illustrative. In some embodiments, motors 72A and 72B may be used to move portions 27A and 27B directly. Alternatively or additionally, a single motor, in combination with symmetric telescoping cable 42, may be used to adjust both portions 27A and 27B. In other embodiments, more than two motors may be used.

In some embodiments, if a user pulls on device 10 or headband system 13 (FIG. 1) to remove device 10, motors 72 may sense the increase in force (e.g., may detect the movement of the head-mounted device being pulled away from the head) and may release cable 42 to allow headband system 13 to be quickly removed from the user's head.

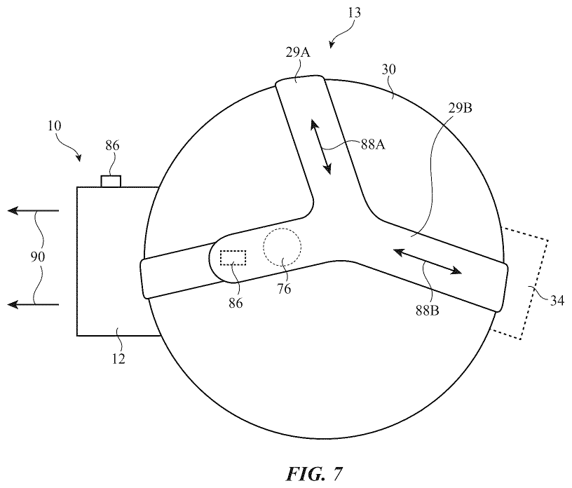

In some embodiments, one or more buttons may be incorporated onto a headband of headband system 13 or onto device 10 to allow for donning and doffing the device. An illustrative example is shown in FIG. 7.

As shown in FIG. 7, system 13 may include two headband portions 29A and 29B. One or both of headband portions 29A or 29B may include motors, such as motors 72, and a symmetric telescoping cable, such as cable 42. As discussed, dial 76, which may be formed on one of headband portions 29A or 29B, or on device 10, may be used to adjust the tension of headband portion 29A and/or headband portion 29B in directions 88A and 88B, respectively.

Alternatively or additionally, device 10 may include button 86. A user may press button 86 when it is desired to don or doff device 10 and headband system 13. For example, when it is desired to don the device, the user may place device 10 and headband system 13 over head 30. The user may then press button 86. In response to a press of button 86, the motors in headband portion 29A and/or headband portion 29B may tighten headband portion 29A and/or headband portion 29B. For example, the motors may tighten headband portion 29A and/or 29B to the most recent tension settings. Alternatively, device 10 may identify the user (e.g., through biometric identification, through a user selection, etc.), and the motors may tighten headband portion 29A and/or 29B to saved settings for the identified user. As another example, the motors may have sensors, such as a voltage/current feedback, that tightens headband portion 29A and/or 29B until the sensors indicate that an appropriate force is applied to the user's head by the headband portion.

When it is desired to doff device 10 and headband system 13, the user may again press button 86. In response to the press of button 86, the motors in headband portion 29A and/or headband portion 29B may loosen headband portion 29A and/or headband portion 29B so that device 10 and headband system 13 may be removed from head 30. In this way, motors in headband portion 29A and/or headband portion 29B may be used to adjust the tension of headband portion 29A and/or headband portion 29B when it is desired to don or doff device 10 and headband system 13.

Although button 86 is shown as being on housing 12 of device 10, this is merely illustrative. In some embodiments, button 86 may be incorporated into a headband of system 13, such as in location 86′.

Alternatively or additionally to using button 86 to loosen/tighten headband portion 29A and/or headband portion 29B, button 86 may be used to change one or more adjustment settings of headband system 13. For example, button 86 may be used (e.g., pressed and held, double-tapped, etc.) to switch dial 76 between providing adjustments to headband portion 29A and headband portion 29B. In this way, the tensions of headband portions 29A and 29B may be adjusted using the same dial 76.

Alternatively or additionally to loosening headband portion 29A and/or headband portion 29B in response to input from dial 76 and/or button 86, motors in headband portion 29A and/or headband portion 29B may loosen headband portion 29A and/or headband portion 29B in response to a user attempting to remove device 10 from their face. For example, if a user pulls housing 12 of device 10 in direction 90, circuitry in device 10 (e.g., one or more sensors, such as an accelerometer or other motion sensor) may detect the movement of housing 12 in direction 90 (away from head 30), and motors in headband portion 29A and/or headband portion 29B may loosen headband portion 29A and/or headband portion 29B to allow the user to remove headband system 13 and device 10 from head 30.

In some embodiments, motors in headband portion 29A and/or headband portion 29B may automatically adjust the tension of headband portion 29A and/or headband portion 29B dynamically based on an operating state of device 10 and headband system 13. For example, if device 10 detects that a user is engaging in dynamic activities (e.g., running, walking, playing a game that involves movement, etc.), motors in headband portion 29A and/or headband portion 29B may tighten headband portion 29A and/or headband portion 29B to improve comfort. One the dynamic activities are completed the motors may loosen headband portion 29A and/or headband portion 29B to the previous settings.

Alternatively or additionally, motors in headband portion 29A and/or headband portion 29B may adjust the tension of headband portion 29A and/or headband portion 29B in response to device 10 determining that a user's eyes are too close or far from the displays in device 10. Or the motors in headband portion 29A and/or headband portion 29B may make micro-adjustments periodically (e.g., periodic tension adjustments) while a user is wearing device 10 and headband system 13 to reduce facial fatigue and improve comfort.

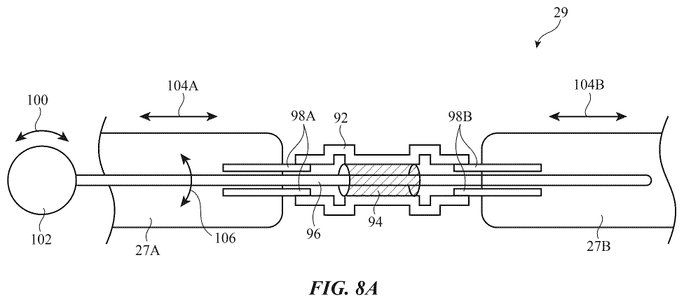

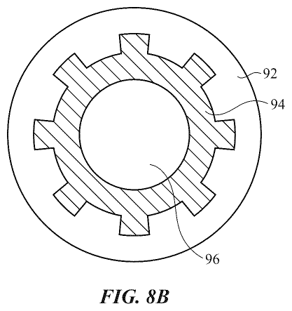

In FIGS. 3-6, symmetric telescoping cable 42 is used to symmetrically adjust two portions of a headband. In some embodiments, symmetric telescoping may be implemented using other mechanisms. For example, a turnbuckle, a lead screw, and/or a rack and pinion mechanism may be used to symmetrically adjust two headband portions. An illustrative example of a headband portion with a turnbuckle for symmetric adjustments is shown in FIG. 8A.

As shown in FIG. 8A, headband portion 29 may include turnbuckle 92 between portion 27A and portion 27B. Turnbuckle 92 may be formed from metal, polymer, or other suitable material. Turnbuckle 92 may be coupled to gear 94 on rod 96 (e.g., a metal or polymer rod). As shown in the illustrative example of FIG. 8B, for example, turnbuckle 92 may be engaged with gear 94, which in turn may be engaged with rod 96.

Returning to FIG. 8A, turnbuckle 92 may also be coupled to thread interfaces on extensions 98A and 98B. Extensions 98A and 98B may be fixedly attached to portion 27A and 27B, and the threaded interface between extensions 98A/98B and turnbuckle 92 may allow turnbuckle 92 to rotate.

In operation, dial 102 may be rotated in directions 100 to rotate rod 96 and gear 94 in directions 106. Gear 94 may rotate turnbuckle 92 in directions 106, which in turn may move portions 27A and 27B in directions 104A and 104B (e.g., due to the threaded interface between extensions 98A/98B and turnbuckle 92). In this way, portions 27A and 27B may be moved symmetrically (e.g., by the same amounts in opposite directions) in response to rotations of dial 102.

Although FIG. 8A shows dial 102 being rotated to rotate turnbuckle 92 and move portions 27A and 27B, this is merely illustrative. In general, any suitable mechanism may be used to rotate turnbuckle 92. For example, one or motors may be used to rotate turnbuckle 92 and move portions 27A and 27B, such as in response to input from a haptic dial, one or more buttons, one or more switches, a slider, voice commands, etc.

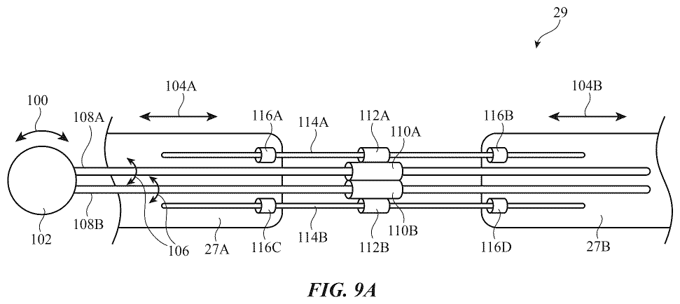

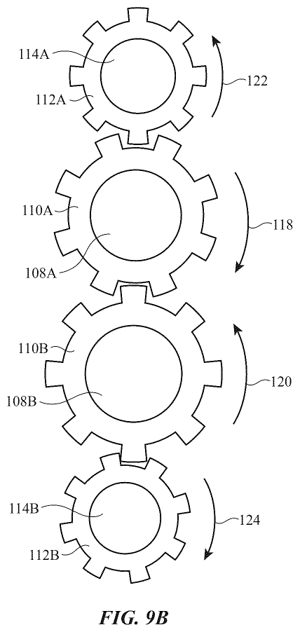

In some embodiments, a spur gear and lead screw may be used to move portions 27A and 27B. An illustrative example is shown in FIG. 9A.

As shown in FIG. 9A, gears 110A and 110B (e.g., spur gears) may be coupled to rods 108A and 108B, respectively. Gears 110A and 110B may have a reduction ratio of 2:1, 2.5:1, or 3:1, as examples, relative to rods 108A and 108B.

Rods 108A and 108B may be coupled to dial 102. Gears 110A and 110B may be coupled to gears 112A and 112B (e.g., spur gears, such as smaller spur gears than gears 110A and 110B), which in turn may be coupled to lead screw drivers 114A and 114B. Lead screw drivers 114A and 114B may be coupled to threaded interfaces 116A, 116B, 116C, and 116D, which in turn may be coupled to portions 27A and 27B.

In operation, dial 102 may be rotated in directions 100 to rotate rods 108A and 108B, as well as gears 110A and 110B, in directions 106. Gears 112A and 112B may rotate in directions 106 in a direction opposite from gears 110A and 110B, which may rotate lead screw drivers 114A and 114B. For example, as shown in FIG. 9B, rod 108A and gear 110A may be rotated in direction 118, which may in turn rotate gear 112A and lead screw driver 114A in direction 122. Similarly, rod 108B and gear 110B may be rotated in direction 120, which may in turn rotate gear 112B and lead screw driver 114B in direction 124. Returning to FIG. 9A, due to the interface between threaded interfaces 116A, 116B, 116C, and 116D, the rotation of lead screw drivers 114A and 114B may move portions 27A and 27B in directions 104A and 104B. In this way, portions 27A and 27B may be moved symmetrically (e.g., by the same amounts in opposite directions) amounts in response to rotations of dial 102.

Although FIG. 9A shows dial 102 being rotated to rotate gears 110A, 110B, 112A and 112B, and move portions 27A and 27B, this is merely illustrative. In general, any suitable mechanism may be used to rotate gears 110A, 110B, 112A and 112B. For example, one or motors may be used to rotate gears 110A, 110B, 112A and 112B and move portions 27A and 27B, such as in response to input from a haptic dial, one or more buttons, one or more switches, a slider, voice commands, etc.

Moreover, although the example of FIG. 9A shows rods 108A and 108B between lead screw drivers 114A and 114B, this is merely illustrative. In some embodiments, lead screw drivers 114A and 114B may be between rods 108A and 108B.

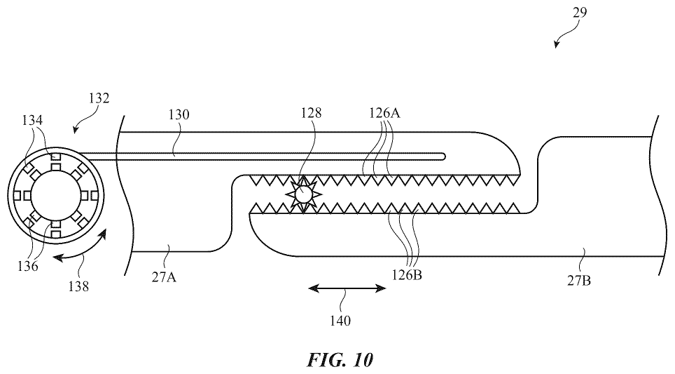

In some embodiments, a rack and pinion system may be used to adjust headband portion 29 symmetrically. An illustrative example is shown in FIG. 10.

As shown in FIG. 10, portions 27A and 27B of headband portion 29 may include teeth 126A and 126B, respectively. Teeth 126A and 126B may engage with teeth of pinion gear 128. In this way, teeth 126A and 126B may form racks in a rack and pinion system with pinion gear 128.

Cable 130 (which may be a cable, rod, belt, or other suitable mechanism) may be coupled to portion 27A and to dial 132. Dial 132 may be a magnetic dial with outer magnets 134 and inner magnets 136. Dial 132 may be rotated in directions 138, and magnets 134 and 136 may form a magnetic clutch, allowing dial 132 to be rotated to pre-determined positions (e.g., when magnets 134 and 136 are aligned) and providing haptic feedback to a user.

By rotating dial 132, cable 130 may be moved in directions 140, thereby moving portion 27A in directions 140. When portion 27A is moved, teeth 126A may move pinion gear 128, causing portion 27B to move symmetrically in the opposite direction as portion 27A. In this way, portions 27A and 27B may be moved symmetrically (e.g., by the same amounts in opposite directions) in response to rotations of dial 132.

In the example of FIG. 10, dial 132 is attached to dial 132, which in turn is attached to headband portion 27A. Therefore, rotating dial 132 moves headband portion 27A. However, this arrangement is merely illustrative. In some embodiments, dial 132 may be coupled to pinion gear 128 directly (or dial 132 may itself include a pinion gear between headband portions 27A and 27B). Therefore, rotating dial 132 may directly move headband portions 27A and 27B due to the engagement of teeth 126A and 126B by the pinion gear. Alternatively, cable 130 may be wrapped around pinion gear 128, rather than being coupled to headband portion 27A. Therefore, rotating dial 132 may rotate pinion gear 128, which may adjust headband portion 29.

Although not shown in FIG. 10 for clarity, headband portion 29, including the rack and pinion system, may be covered with fabric. Therefore, headband portion 29 may be adjustable using the rack and pinion system, but the comfort of a user of headband portion 29 may be increased.

Although FIG. 10 shows dial 132 being rotated to move portions 27A and 27B with a rack and pinion system, this is merely illustrative. In general, any suitable mechanism may be used to move portions 27A and 27B. For example, one or motors may be used move portion 27A, which in turn may move portion 27B symmetrically due to the rack and pinion system, such as in response to input from a haptic dial, one or more buttons, one or more switches, a slider, voice commands, etc. Alternatively a non-haptic dial (e.g., dial 102 of FIGS. 3-9) may be used to move portions 27A and 27B.

A magnetic dial, such as dial 132, may be used as an input for any suitable adjustment mechanism for headband portion 29, such as any of the adjustment mechanisms shown in FIGS. 3-9.

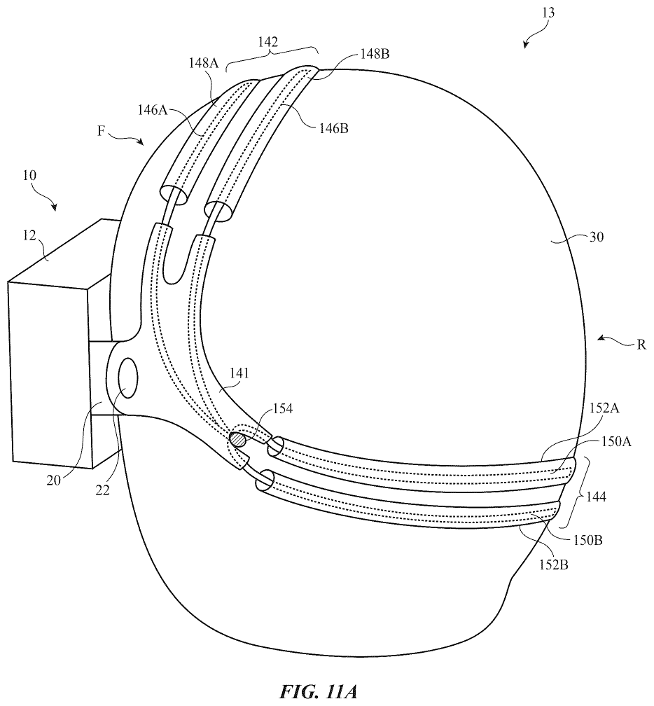

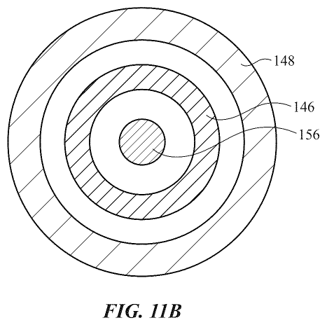

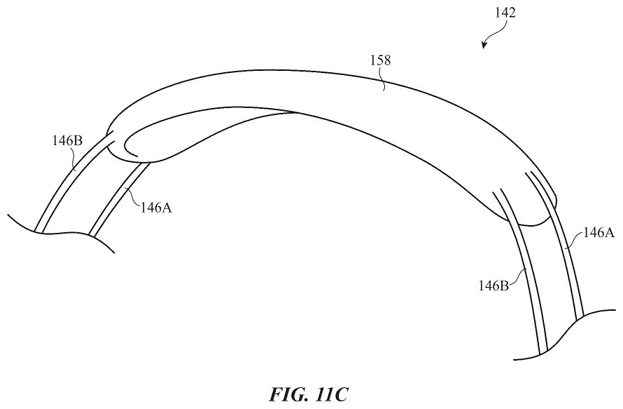

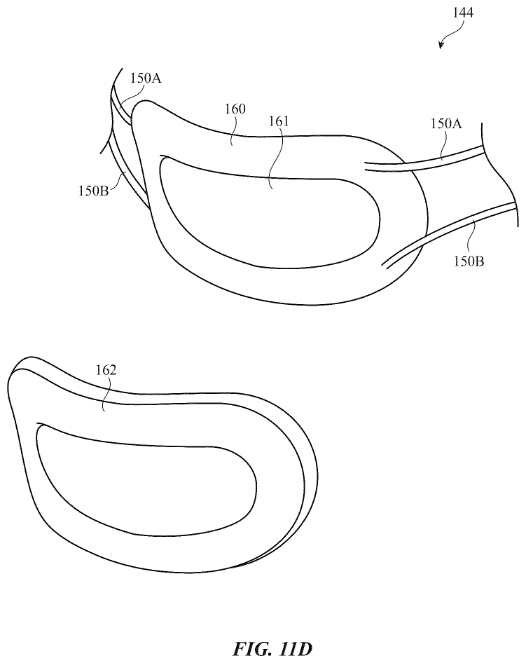

In some embodiments, a headband system, such as headband system 13 (FIG. 1) may include headband portions formed from tubes, such as telescoping tubes. An illustrative example is shown in FIG. 11A.

As shown in FIG. 11A, headband system 13 may include upper headband portion 142 and lower headband portion 144 coupled to central portion 141. Upper headband portion 142 may be provided on a top of head 30 or on an upper portion of rear R of head 30, as examples. Lower headband portion 144 may be provided on a lower portion of rear R of head 30 or another suitable portion of rear R of head 30, as examples. Central portion 141 may attach headband system 13 to device 10, such as by attaching to connection 22 of extension 20.

Upper headband portion 142 may include first tube 146A and second tube 146B (also referred to as inner tubes 146A and 146B herein). First tube 146A and second tube 146B may be telescoping tubes that can telescope in length and therefore may be referred to as telescoping tubes 146A and 146B herein. Tubes 146A and 146B may be formed from metal, polymer, or another suitable material. Tubes 146A and 146B may be surrounded by outer tubes 148A and 148B, respectively. Outer tubes 148A and 148B may be formed from a polymer, such as high-density polyethylene (HDPE), polytetrafluoroethylene (PTFE), or another suitable material. For example, outer tubes 148A and 148B may be in contact with head 30, so may be formed from a softer material than tubes 146A and 146B.

Similarly, lower headband portion 144 may include first tube 150A and second tube 150B (also referred to as inner tubes 150A and 150B herein). First tube 150A and second tube 150B may be telescoping tubes that can telescope in length and therefore may be referred to as telescoping tubes 150A and 150B herein. Telescoping tube 150A may be configured to rest against an upper portion of a rear of the user's head, and telescoping tube 150B may be configured to rest against a lower portion of the rear of the user's head. Tubes 150A and 150B may be formed from metal, polymer, or another suitable material. Tubes 150A and 150B may be surrounded by outer tubes 152A and 152B, respectively. Outer tubes 152A and 152B may be formed from a polymer, such as high-density polyethylene (HDPE), polytetrafluoroethylene (PTFE), or another suitable material. For example, outer tubes 152A and 152B may be in contact with head 30, so may be formed from a softer material than tubes 150A and 150B.

A cable, such as an elastic cable, may extend into tube 146A, tube 146B, tube 150A, and/or tube 150B. The cable may be attached to pull tab 154. A user of device 10 and headband system 13 may adjust tube 146A, tube 146B, tube 150A, and/or tube 150B by pulling pull tab 154.

Although not shown in FIG. 11A for clarity, fabric may be used to cover tubes 148A and 148B (or tubes 146A and 146B if tubes 148A and 148B are omitted) of headband portion 142 and/or to cover tubes 152A and 152B (or tubes 150A and 150B) of headband portion 144. Therefore, headband portions 142 and 144 may be adjustable using the rack and pinion system, but the comfort of a user of headband system 13 may be increased.

A side view of an illustrative tubes in headband system 13 is shown in FIG. 11B. In particular, outer tube 148 may surround telescoping tube 146. Cable 156, which may be an elastic cable or cable of another suitable material, may be embedded in tube 146. By adjusting cable 156, tube 146 may be adjusted. In other words, because tube 146 is telescoping, adjusting cable 156 may adjust a length of tube 146, thereby adjusting a tension of tube 146 on head 30.

Cable 156 may be adjusted directly using pull tab 154, may be adjusted using a dial (e.g., as shown in FIGS. 4 and 5), may be adjusted with one or more motors, one or more buttons, one or more sliders, or one or more switches as examples. Alternatively or additionally, cable 156 may be omitted, and a motor may adjust tube 146 directly.

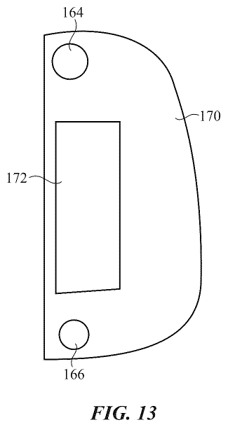

In some embodiments, cable 156 may be omitted and replaced by a wire stiffener, or a wire stiffener may otherwise be incorporated into a tube of headband system 13. The wire stiffener may be formed from a metal wire, such as a nitinol wire, or from another stiffening material. If desired, the wire stiffener may also be coupled to one or more temples of headband system 13, such as to central portion 141 of FIG. 13. In this way, one or more tubes in headband system 13 may be stiffened.

In general, each of tubes 146A, 146B, 150A, and 150B may have an embedded cable or other suitable mechanism, and the tension of each tube may be adjusted to adjust the tension of headband system 13. Because each tube 146A, 146B, 150A, and 150B contacts a different portion of head 30, allowing individual adjustment of each tube may allow for a better fit.

Alternatively or additionally, the angle between each of tubes 146A, 146B, 150A, and 150B may be adjusted so that a user may change the portion of head 30 on which each of tubes 146A, 146B, 150A, and 150B rests.

The example of FIG. 11B, which includes outer tube 148, tube 146, and cable 156, is merely illustrative. In general, tubes in headband system 13 may include any suitable number of layers (e.g., tubes).

In some embodiments, tubes 146A and 146B and/or tubes 150A and 150B may be covered, such as to improve user comfort. Illustrative examples are shown in FIGS. 11C and 11D.

As shown in FIG. 11C, pad 158 may be included in headband portion 142. Pad 158 may be formed from a polymer, elastomer, rubber, foam, and/or other suitable material. Pad 158 may include openings through which tubes 146A and 146B are routed. In this way, pad 158 may contact head 30 (FIG. 11A) rather than tubes 146A and 146B, providing enhanced comfort.

Although FIG. 11C shows tubes 146A routed through pad 158 without outer tubes 148 (FIG. 11A), this is merely illustrative. Pad 158 may be used with or without outer tubes 148.

As shown in FIG. 11D, pad 160 may be included in headband portion 144. Pad 160 may be formed from a polymer, elastomer, rubber, foam, and/or other suitable material. Pad 160 may include openings through which tubes 150A and 150B are routed. In this way, pad 160 may contact head 30 (FIG. 11A) rather than tubes 150A and 150B, providing enhanced comfort.

Pad 160 may surround central opening 161. Central opening 161 may allow a user's hair to pass through, providing additional comfort to the user. However, this is merely illustrative. In some embodiments, pad 160 may be provided without central opening 161.

Although FIG. 11D shows tubes 150A and 150B routed through pad 160 without outer tubes 152 (FIG. 11A), this is merely illustrative. Pad 160 may be used with or without outer tubes 152.

In some embodiments, removable weight 162 (also referred to as removable weighetd component 162 herein) may be attached to pad 160. Removable weight 162 may be attached to pad 160 magnetically, with snaps, or with any other suitable mechanism. Removable weight 162 may be formed from metal or polymer (e.g., fabric-covered metal or polymer), weighted pellets in a textile, or any other suitable material. If desired, removable weight 162 may provide a counterbalance force to the weight of device 10 (FIG. 11A).

Instead of, or in addition to, removable weight 162, a removable battery may be attached to pad 160 (e.g., using one or more magnets, clips, and/or other attachments) and may be electrically coupled to device 10 to provide additional power to device 10, when desired.

The use of two tubes in each of headband portions 142 and 144 is merely illustrative. In general, any suitable number of tubes, such as one tube, two tubes, or three tubes, may be used in each of headband portions 142 and 144. Alternatively or additionally, more than two headband portions, or a single headband portion, may be incorporated into headband system 13.

Although pad 160 is shown in FIG. 11D as being attached to headband portions 142 and 144 with tubes, this is merely illustrative. In general, pad 160 may be attached to any suitable headband, such as a headband formed from fabric. An attachment, such as removable weight 162 and/or a removable battery, may be attached to pad 160. Alternatively or additionally, pad 160 may be formed integrally with fabric of a headband (e.g., the fabric may surround an opening, such as central opening 161).

Although FIGS. 11A-11D show upper and lower headband portions 142 and 144 with tubes, this is merely illustrative. In some embodiments, upper headband portion 142 with tubes 146 may be used in headband system 13 with headband portion 29 (FIGS. 2-10). Alternatively, lower headband portion 144 with tubes 150 may be used in headband system 13 with headband portion 29.

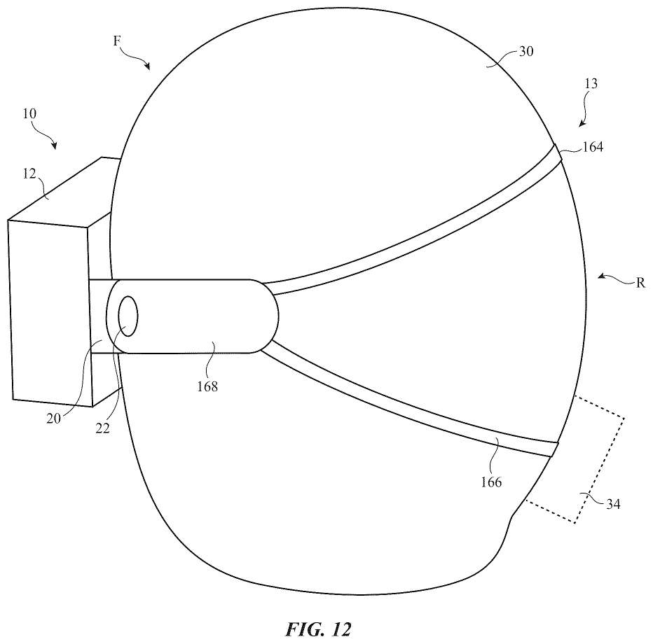

Instead of providing upper and lower headband portions 142 and 144, each with adjustable tubes, in headband system 13, a single upper and lower tube may be incorporated into headband system 13. An illustrative example is shown in FIG. 12.

As shown in FIG. 12, headband system 13 may include tube 164 on an upper portion of rear R of head 30 and tube 166 on a lower portion of rear R of head 30. Tubes 164 and 166 may be telescoping tubes (e.g., as shown in FIG. 11B) and may correspond with any of tubes 146A, 146B, 150A, and/or 150B (FIG. 11A). Tubes 164 and 166 may be coupled to central portion 168, which in turn may be coupled to device 10. Optional component 34, which may b be a removable weight, a removable battery, or another suitable component may be coupled to tube 166, if desired.

Although FIG. 12 shows tube 164 at the upper portion of rear R and tube 166 at the lower portion of rear R, this is merely illustrative. In general, tube 164 may be formed on any suitable portion of head 30, such as the top of head 30 or an upper portion of front F or rear R. Similarly, tube 166 may be formed on an upper or lower portion of rear R. Alternatively or additionally, more than two tubes may be used in system 13.

In embodiments in which one or more tubes is used in headband system 13, such as in the example of FIG. 11A or 12, the tubes may be embedded in an enclosure that also includes one or more suitable components. An illustrative example is shown in FIG. 13.

As shown in FIG. 13, tubes 164 and 166 may be embedded in enclosure 170. Enclosure 170 may be formed from a polymer, elastomer, rubber, foam, and/or other suitable material. In other words, enclosure 170 may be a padded enclosure. Enclosure 170 may include openings through which tubes 164 and 166 are routed. In this way, padded enclosure 170 may contact head 30 (FIG. 12) rather than tubes 164 and 166, providing more enhanced comfort.

In addition to including tubes 164 and 166 in enclosure 170, one or more components, such as component 172 may be included in enclosure 170. For example, component 172 may be a battery that is coupled to device 10 (FIG. 12) and/or may include a counterweight (e.g., a removable weighted component). In this way, a battery, a counterweight, and/or tubes 164 and 166 may be incorporated into enclosure 170.

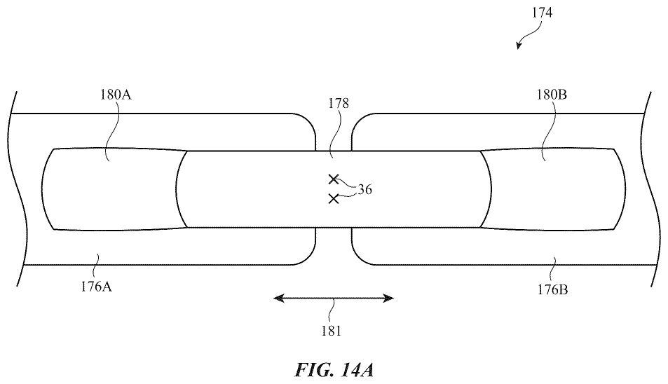

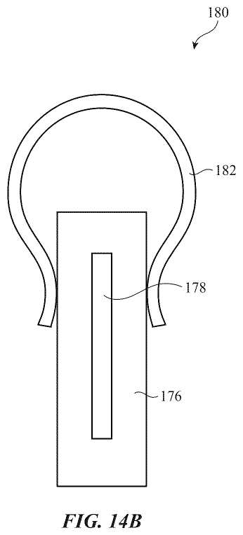

Instead of, or in addition to, incorporating tubes or a symmetric adjustment mechanism in a headband portion of a headband system, a friction channel may be used to allow for adjustments to the tension of the headband portion. An illustrative example is shown in FIGS. 14A and 14B.

As shown in FIG. 14A, headband portion 174 may include headband portions 176A and 176B. Headband portion 174 may correspond with headband portion 24 or headband portion 26 of FIG. 1, or another suitable headband portion of system 13. Headband portions 176A and 176B may be formed from, for example, fabric portions with embedded stiffeners, such as embedded polymers; elastomer; polymer; and/or other suitable material(s). In some embodiments, headband portions 176A and 176B may include thermoplastic polyurethane (TPU) or another suitable polymer.

Headband portion 174 may also include support 178 between headband portions 176A and 176B. Support 178 may be formed from elastomer, polytetrafluoroethylene (PTFE), metal (e.g., sheet metal), or another suitable material. Support 178 may be fastened to component 34 (FIG. 2A) at fasteners 36, or support 178 may not be fastened to component 34 (e.g., component 34 may be omitted).

Headband portions 176A and 176B may be coupled to support 178 and may move slidably relative to support 178. For example, support 178 may slide within channels 180A and 180B in directions 181. By sliding headband portions 176A and 176B closer together, headband portion 174 may be tightened. By sliding headband portions 176A and 176B further apart, headband portion 174 may be loosened. In this way, headband portion 174 may be adjusted.

Channels 180A and 180B may be friction channels. In particular, a friction member, such as a clasp (e.g., a spring clasp) or clamp, may maintain the position of portions 176A and 176B relative to support 178. Only when enough force is exerted on portion 176A and/or 176B (e.g., directly by a user, through a cable, by a motor, etc.), will portion 176A and/or 176B move relative to support 178. An illustrative side view of a friction channel is shown in FIG. 14B.

As shown in FIG. 14B, friction channel 180 may include support 178 in (or partially in) portion 176 of headband portion 174. Friction member 182, which may be a clamp, clasp (e.g., a spring clasp), or other suitable friction member, may apply a force to portion 176 and support 178, thereby maintaining the position of portion 176 relative to support 178.

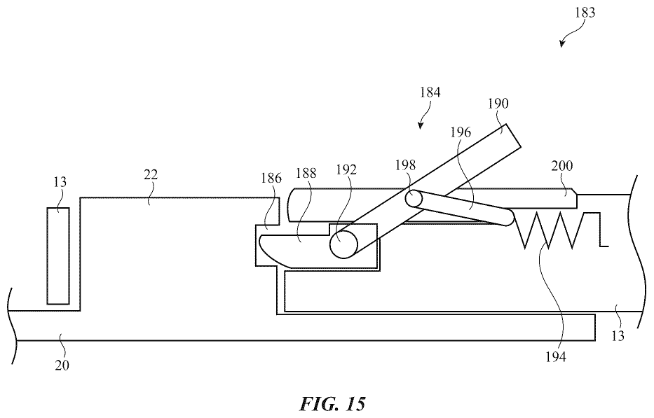

Regardless of the type(s) of headband portions used in headband system 13, headband system 13 may be attached to a head-mounted device, such as head-mounted device 10 (FIG. 1) at connection 22. Connection 22 may include one or more posts and latches to attach headband system 13 to device 10. An illustrative example is shown in FIG. 15.

As shown in FIG. 15, connection region 183 may include post 22 on extension 20. Extension 20 may be coupled to housing 12 of device 10 (FIG. 1). Headband system 13 may be attached to extension 20 (and therefore to device 10) at post 22. In particular, headband system 13 may include latch mechanism 184, including latch 188 that extends into recess 186 of post 22.

Latch 188 may be extended into recess 186 and retracted out of recess 186 using lever 190. In particular, lever 190 may be coupled to latch 188 about pivot 192. When lever 190 is lifted up, latch 188 may be retracted out of recess 186. When lever 190 is pushed downward into recess 200 in headband system 13, latch 188 may be extended into recess 186. In this way, lever 190 may be used to lock headband system 13 onto extension 20 of device 10.

Spring 194 may be coupled to lever 190 via pivot 198. Spring 194 may ensure that lever 190 remains in place in recess 200 when it is not desired to remove headband system 13 from extension 20.

Although FIG. 15 shows a single latch 188 locking headband system 13 to post 22, this is merely illustrative. In general, one or more latches (e.g., a latch on one or more sides of post 22) may be used to lock headband system 13 to post 22.

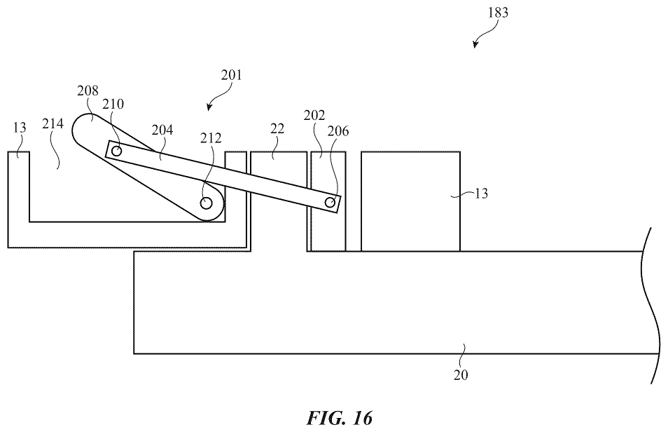

Instead of, or in addition to, including a latch that extends into a recess of post 22, headband system 13 may include a latch that clamps post 22. An illustrative example is shown in FIG. 16.

As shown in FIG. 16, headband system 13 may include latch mechanism 201, including latch 202 that clamps onto post 22 of extension 20. In particular, latch 202 may be coupled to bar 204 at pivot 206. Bar 204 may be coupled to lever 208 at pivot 210, and lever 208 may be coupled to a portion of headband system 13 at pivot 212.

By moving lever 208 downward into recess 214 of headband system 13, latch 202 may be clamped onto post 22, thereby locking headband system 13 to extension 20 of device 10. When it is desired to remove system 13 from device 10, lever 208 may be lifted up and out of recess 214 to unclamp latch 202 from post 22. In this way, latch mechanism 201 may removably couple headband system 13 to extension 20 of device 10.

Although not shown in FIG. 16, one or more springs or other suitable components (e.g., spring 194 of FIG. 15) may be coupled to lever 208 to ensure that lever 208 remains in place in recess 214 when it is not desired to remove headband system 13 from extension 20.

Although FIGS. 15 and 16 show and describe post 22 on extension 20 of device 10 and latch mechanism 184 or 201 on headband system 13, this is merely illustrative. In some embodiments, post 22 may be on headband system 13, and a latch mechanism, such as latch mechanism 184 or 201 may be on extension 20 of device 10.

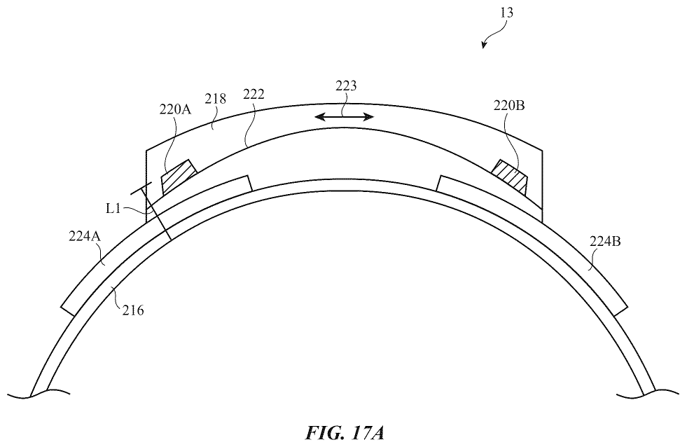

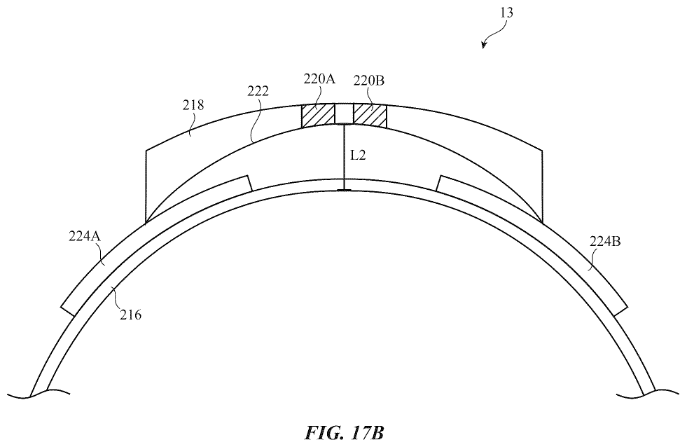

As discussed, a weight, such as a removable weight (e.g., a removable weighted component), may be attached to a rear portion of headband system 13 to counterbalance the weight of device 10. In some embodiments, it may be desirable to adjust the weight. An illustrative example is shown in FIGS. 17A and 17B.

As shown in FIG. 17A, headband system 13 may include headband portion 216. Headband portion 216 may be a rear headband portion, such as rear headband portion 26 (FIG. 1).

Weight assembly 218 may be attached to headband portion 216, such as using adhesive 224A and 224B. In general, however, weight assembly 218 may be attached to headband portion 216 using any suitable attachment, such as a magnetic attachment.

Weight assembly 218 may include weights 220A and 220B on ramp 222. For example, weights 220A and 220B may be slidably coupled to ramp 222. In particular, weights 220A and 220B may be moved in directions 223 to adjust a distance between weights 220 and a rear of the user's head when headband system 13 is worn. In FIG. 17A, weights 220A and 220B may be a distance L1 from a rear of the user's head when headband system 13 is worn. In FIG. 17B, weights 220A and 220B may have been moved further, such as to a distance L2, from the user's head. Positioning weights 220 further from the user's head (e.g., at distance L2) will increase the moment of weights 220, thereby producing a greater counterbalance force to offset the force of device 10.

Weights 220A and 220B may be moved in directions 223 manually (e.g., by a user to increase comfort) or automatically (e.g., weights 220 may be positioned automatically based on the tightness of headband portion 216). For weights 220 to be positioned automatically based on the tightness of headband portion 216, weights 220 and/or ramp 222 may be attached to headband portion 216 so that weights 220 and/or ramp 222 are moved when headband portion 216 is moved during tightening/loosening operations.

For example, weights 220A and 220B may be automatically moved to the position shown in FIG. 17A (e.g., close to the user's head) if the user has a large head. In contrast, weights 220A and 220B may be automatically moved to the position shown in FIG. 17B (e.g., further from the user's head) if the user has a small head to increase the counterbalance provided by weights 220A and 220B.

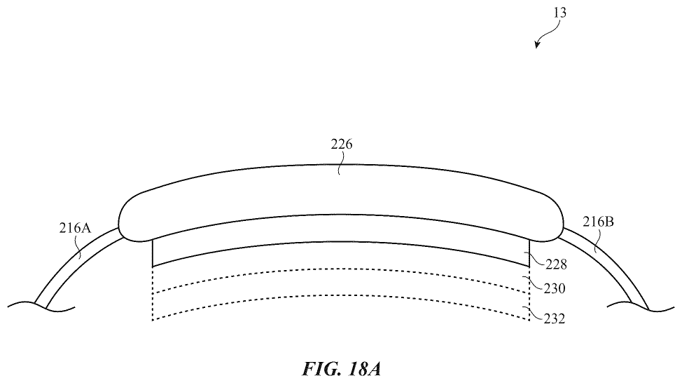

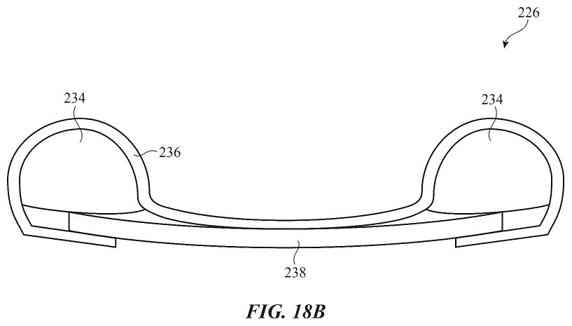

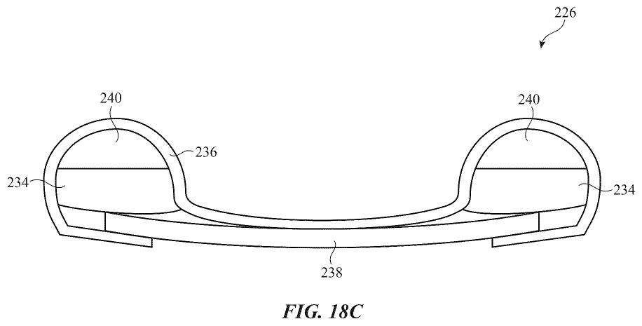

Instead of, or in addition to, including adjustable weights in headband system 13, removable weights, batteries, and/or other components may be attached to headband system 13 to accommodate different head sizes. An illustrative example is shown in FIG. 18A.

As shown in FIG. 18A, headband portions 216A and 216B of headband system 13 may be coupled to component 226. Component 226 may be a battery (e.g., a fixedly attached battery or a removable batter), a weight (e.g., a fixedly attached weight or a removable weight), a padded member (e.g., an elastomer or foam member) for user comfort, or another suitable component. If component 226 is a weighted member, component 226 may be a metal or polymer weight covered by textile, a textile filled with weighted pellets (e.g., metal or polymer pellets), or another suitable weight. A cross-sectional view of an illustrative weighted member that may be used for component 226 is shown in FIG. 11B.

As shown in FIG. 11B, component 226 may include weight 234. Weight 234 may be a metal, a polymer, a weighted bean bag, or other suitable weight. In some illustrative embodiments, weight 234 may be a weighted bean bag, such as a textile filled with tungsten (or other metal) pellets to ensure that weight 234 is compliant on the rear of a user's head when headband system 13 is worn.

Textile 236 may cover weight 234. Textile 236 may be any suitable fabric. Alternatively, textile 236 may include foam or elastomer. Layer 238 may cover a rear portion of component 226 and may seal component 226. For example, one or more adhesives may be provided between layer 238, textile 236, and/or weight 234. Layer 238 may be formed from a polymer, a metal, an elastomer, or another suitable material. Although not shown in FIG. 11B, weight 234 and/or textile 236 may extend over layer 238, if desired.

In some embodiments, a foam may be provided over weight 234. As shown in the illustrative example of FIG. 18C, foam 240 may be provided over weight 234. In particular, foam 240 may be interposed between weight 234 and the user's head when headband system 13 is worn. Therefore, foam 240 may provide cushioning for the user's head and may increase the compliance of component 226 against the user's head.

Although foam 240 is shown as overlapping only the top surface of weight 234, this is merely illustrative. In general, foam 240 may wrap around some or all of weight 234.

In general, any suitable weight (or other component) may be used to form component 226 of FIG. 18A. As further shown in FIG. 18A, a counterbalance mass 228 may be attached to an inner surface of component 226. For example, counterbalance mass 228 may be removably attached to component 226, such as through a snap-to-fit mechanism, magnets, or any other suitable attachment. Counterbalance mass 228 may be a rigid or flexible counterbalance mass and may be formed from metal, polymer, elastomer, weighted pellets, and/or textile. Counterbalance mass 228 may be interposed between component 226 and the user's head when headband system 13 is worn.

To ensure that counterbalance mass 228 provides a sufficient counterbalance for device 10, counterbalance mass 228 may be weighted and sized to ensure a proper counterbalance and fit for a user of headband system 13. For example, as shown in FIG. 18A, larger counterbalance mass 230 or 232 may be used, depending on the size of the user's head and/or the mass of device 10. In this way, a counterbalance mass may be attached to component 226 to provide maximal comfort for a user of headband system 13.

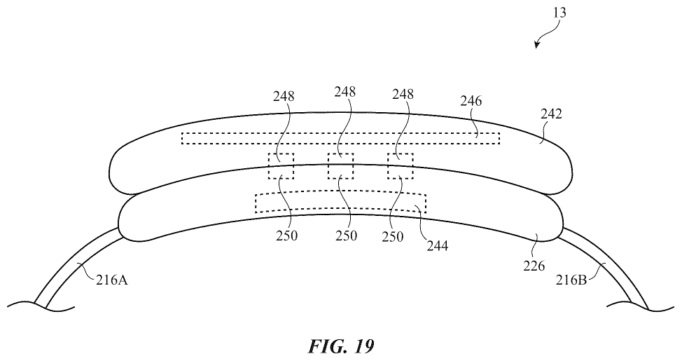

Although counterbalance mass 228 is shown as being attached to the inner surface of component 226, this is merely illustrative. In some embodiments, counterbalance mass 228 may be attached to an exterior surface of component 226 (e.g., component 226 may be interposed between counterbalance mass 228 and the user's head when headband system 13 is worn). For example, as shown in the illustrative example of FIG. 19, weighted component 242 may be removably attached to an exterior surface of component 226 (e.g., opposite the user's head when worn). Component 226 may be a rigid or flexible component.

Weighted component 242 may be, for example, a removable battery. In particular, component 242 may include battery 246. Component 226 may be fixedly attached to headband portions 216A and 216B, and may include battery 244. However, in some embodiments, battery 244 may be omitted from component 226, and battery 246 may be attached to a head-mounted device directly via a cord.

In some embodiments, battery 244 may be smaller (e.g., have a smaller capacity, weight less, etc.) than battery 246. However, this is merely illustrative. In some embodiments, battery 244 may be larger than battery 246, or battery 244 may be the same size as battery 246.

Component 242 may include magnets 248 that may be removably coupled with magnets 250 in component 226. In this way, component 242 may be removably coupled to component 226. When component 242 is removably coupled to component 226, battery 246 may recharge battery 244 (e.g., through one or more coils in component 242 and component 226 that enable wireless charging). Alternatively or additionally, battery 246 may be directly coupled to device 10. In this way, a removable battery (or other weight) may be coupled to component 226 at the rear of headband system 13.

Although component 242 is shown as being magnetically attached to component 226, this is merely illustrative. In some embodiments, component 242 may be attached to component 226 using clips and/or other suitable attachments. Alternatively, headband portions 216A and 216B may be formed from and/or covered with fabric, and the fabric may include a pocket in which component 242 is inserted. For example, headband portions 216A and 216B may include tubes (e.g., the tubes of FIG. 11A), and the tubes may extend above and below component 242 when it is inserted in the fabric of headband portions 216A and 216B. in general, however, component 242 may be coupled to headband portions 216A and 216B in any suitable manner.

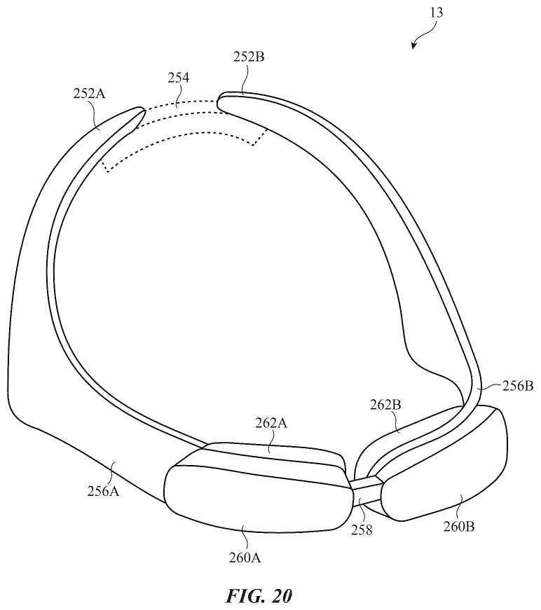

In some embodiments, a weighted component may be attached to a portion of headband system as multiple split components, allowing for greater customization of user fitment. An illustrative example is shown in FIG. 20.

As shown in FIG. 20, headband system 13 may include upper headband portions 252A and 252B and lower headband portions 256A and 256B. Upper headband portions 252 may rest on a top portion of a user's head, while lower headband portions 256 may rest against a lower rear portion of the user's head. Upper headband portions 252 and lower headband portions may be formed from polymer, textile, and/or other suitable materials.

Lower headband portions 256A and 256B may be separated by a gap and may be coupled by lower extension 258 that extend across the gap. Lower extension 258 may be, for example, an elastomer member or other flexible member that allows lower headband portions 256A and 256B to separate from one another to accommodate the user's head.

Weights 260A and 260B may be attached to lower headband portions 256A and 256B, respectively. Weights 260 may be metal, polymer, weighted pellets in a textile, or other suitable weights that are attached to lower headband portions 256 with adhesive, or may be removably attached with magnets, snaps, or another attachment mechanism. When headband system 13 is worn, portions 256, and therefore weights 260, may be pushed apart based on a size of the user's head, thereby providing appropriate counterbalancing for device 10. In some embodiments, weights 260 may also be movable (e.g., slidable) along headband portions 256 to allow further customization to the counterbalancing of device 10.

Pads 262A and 262B, which may be elastomeric, foam, or otherwise compliant pads, may be attached to an inner surface of lower headband portions 256A and 256B, respectively. Pads 262 may rest against the lower rear of the user's head when headband system 13 is worn.

Upper headband portions 252A and 252B may similarly be separated by a gap and may be coupled by upper extension 254 that extend across the gap. Upper extension 254 may expand based on the size of the user's head when the user wears headband system 13. Upper extension 254, which may be a polymer, elastomer, foam and/or other suitable material, may extend between upper headband portions 252A and 252B and may contact the user's head when headband system 13 is worn. In other words, upper extension 254 may accommodate the expansion of upper headband portions 252, while providing comfort for the user.

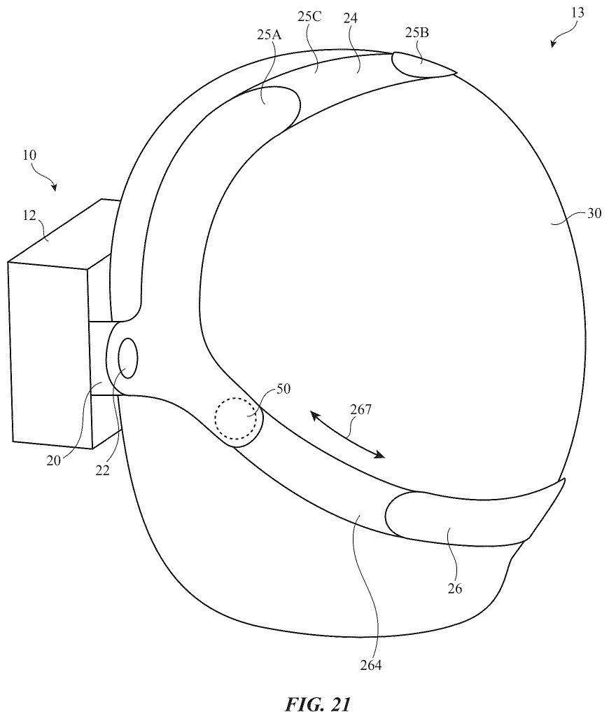

Regardless of the type of headband used in headband system 13, one or more headband portions of headband system 13 may include one or more stretchable portions to allow headband system 13 to be removed from the user's head while maintaining the tension settings of headband system 13. An illustrative example is shown in FIG. 21.

As shown in FIG. 21, headband system 13 may include stretchable portion 264 of lower headband portion 26. Stretchable portion 264 may be formed from elastomer, fabric, or another suitable stretchable material.

The tension of lower headband portion 26 may be adjusted, such as using dial 50 or any other desired adjustment mechanism. When the user removes headband system 13 from headband system 13, stretchable portion 264 may stretch in directions 267, allowing system 13 to be removed from head 30. When the user puts headband system 13 back on head 30, stretchable portion 264 may again stretch in directions 267 to allow headband system 13 to fit over head 30. Once on head 30, lower headband portion 26 may have the same tension it had prior to removal from head 30. In this way, stretchable portion 264 may allow for the removal of headband system 13 while maintaining the tension of at least a portion of headband system 13.

Although stretchable portion 264 is shown in lower headband portion 26, this is merely illustrative. In general, stretchable portion 264 may be included in lower headband portion 26 and/or upper headband portion 24.

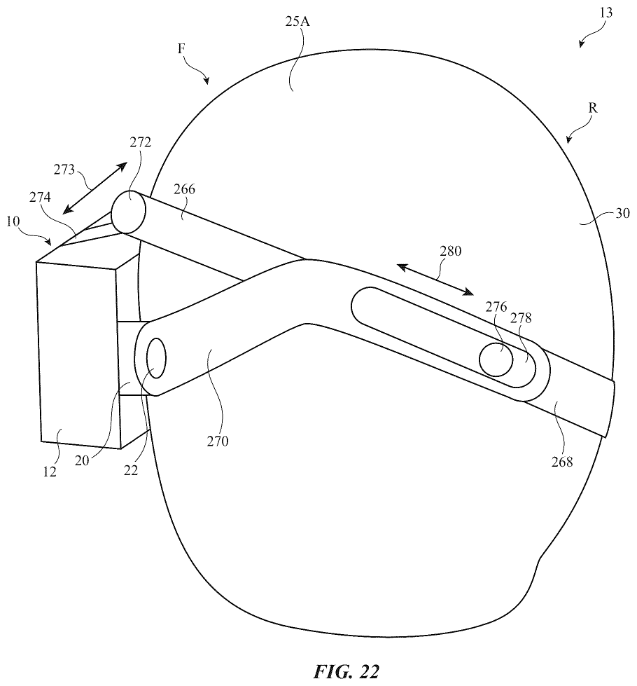

In the examples of FIGS. 1-21, headband portions are provided at the top and/or rear of the user's head when a headband system is worn. In some embodiments, however, it may be desirable to provide a headband system with a front strap. An illustrative example is shown in FIG. 22.

As shown in FIG. 22, headband system 13 may be provided on head 30. Headband system 13 may include headband portion 266 at front F of head 30 and headband portion 268 at rear R of head 30. Headband portions 266 and 268 may extend from central portion 270, which may attach headband system 13 to device 10 at connection 22.

Headband portion 266, headband portion 268, and central portion 270 may be formed from polymer, elastomer, metal, and/or fabric as examples. In some illustrative embodiments, at least some (if not all) of headband portion 266, headband portion 268, and central portion 270 may be stiff, such as being formed from stiff polymer. However, this is merely illustrative. headband portion 266, headband portion 268 may be formed from flexible materials, if desired.

Headband portion 266 may be attached to housing 12 of device 10 using adjustable extension 274. Adjustable extension 274 may be formed from fabric or polymer, as examples. Adjustable extension 274, and therefore device 10, may be moved in directions 273 to move device 10 closer or further from the user's face. To lock device 10 into a desired position relative to the user's face, a component, such as dial 272, may be tightened to lock the position of device 10 and adjustable extension 274 relative to the user's face. In this way, headband portion 266 may maintain device 10 in a desired portion of the user's face. Device 10 may then contact the user's face along an entire periphery of device 10, or a single edge (e.g., a top edge) of device 10 may contact the user's face (e.g., the user's forehead).

Headband portion 268 may provide support on rear R of head 30. Additionally, headband portion 268 may form a cantilever to counterbalance the weight of device 10. In particular, headband portion 268 may include slidable weight 276 in channel 278. Slidable weight 276 may be slid in directions 279 and may provide a counterbalance to device 10. By moving weight 276 further from device 10, a larger counterbalance may be provided. By moving weight 276 closer to device 10, a smaller counterbalance may be provided. A user of device 10 may manually move weight 276 within channel 278, or the position of weight 276 may be adjusted by circuitry in device 10 (e.g., by one or more motors in headband system 13 that are controlled by circuitry in device 10). In this way, device 10 may rest on the user's face and may be supported by headband portion 266 and may be counterbalanced by headband portion 268.

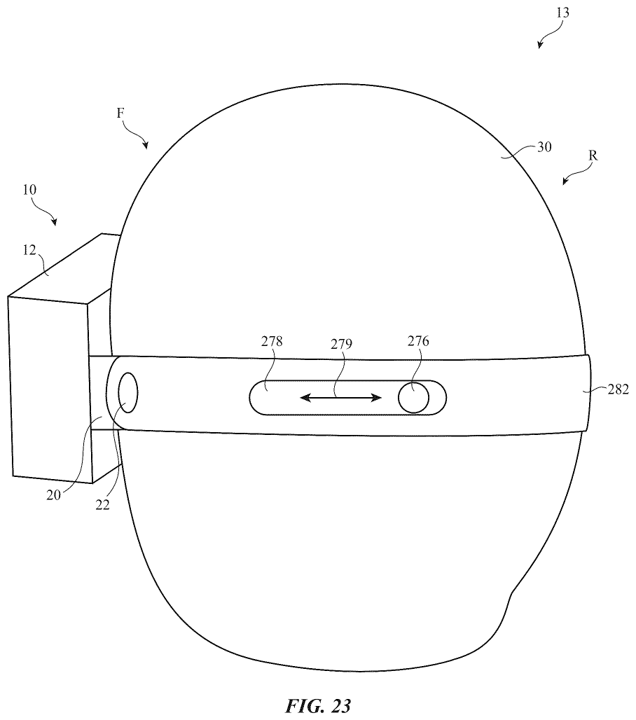

Although FIG. 22 shows a cantilever in a lower rear headband portion of a headband system with multiple headband portions, this is merely illustrative. In general, a cantilever may be incorporated into any suitable headband portion of any desired headband system. For example, as shown in the illustrative example of FIG. 23, headband system 13 may include a single headband portion 282 that rests at a central portion of rear R of head 30. Weight 276 may be adjusted in directions 279 within channel 278 of headband portion 282 to counterbalance device 10 as it rests on the user's face.

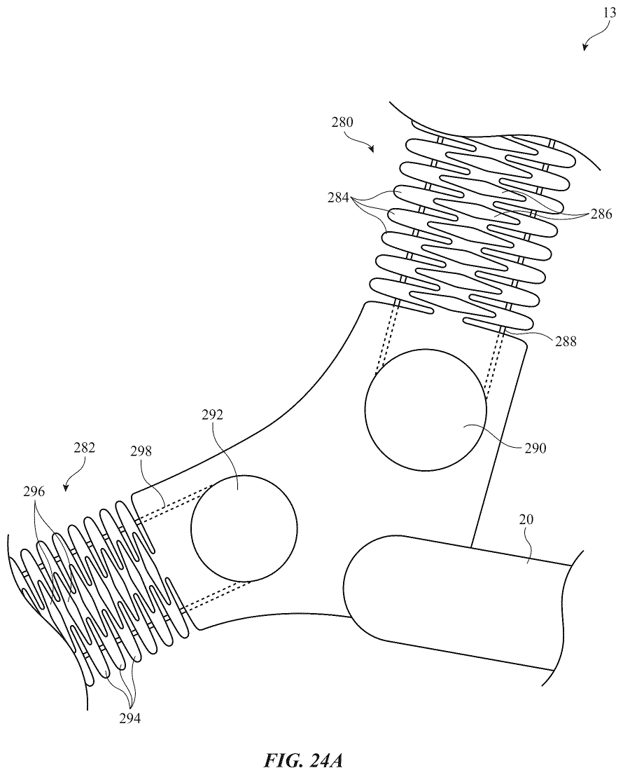

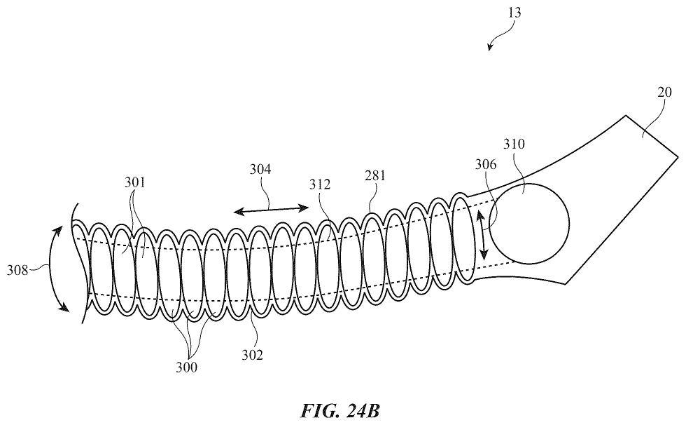

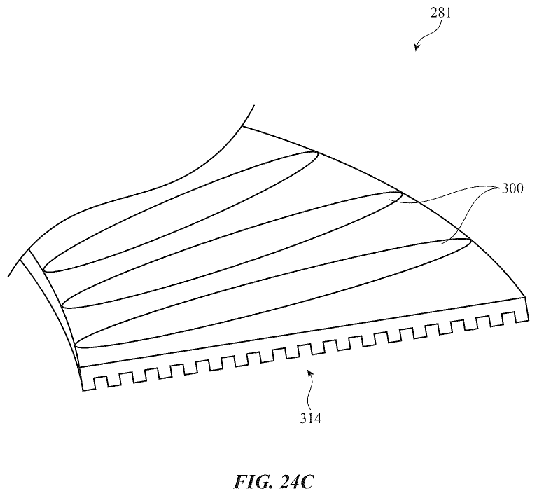

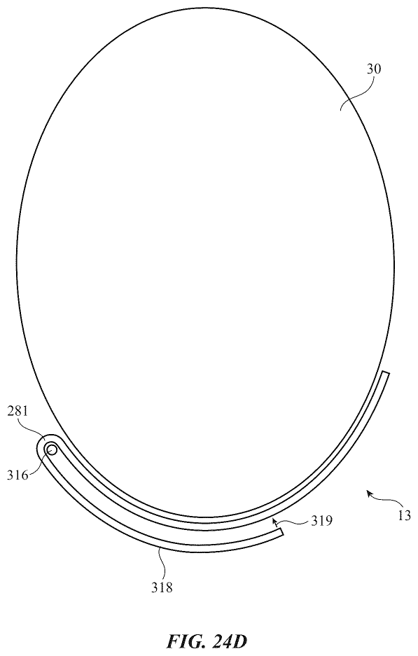

In some embodiments, a headband system may include one or more headband portions with molded, flexible components. These molded components may include lattice structures, molded elliptical structures, and/or other suitable molded structures. An illustrative example is shown in FIG. 24A.

As shown in FIG. 24A, headband system 13 may include headband portion 280 (which may correspond with headband portion 24 of FIG. 1) and headband portion 282 (which may correspond with headband portion 26 of FIG. 1). Headband portions 280 and 282 may be formed from molded lattices (e.g., molded components), such as lattices of molded polymer (or another suitable material). In particular, headband portion 280 may include lattice structures 284 with openings 286 between lattice structures 284. Similarly, headband portion 282 may include lattice structures 294 and openings 296 between lattice structures 294. Cable 288 may be routed through lattice structures 284 and may be tightened and loosed using dial 290 to adjust headband portion 280. Cable 298 may be routed through lattice structures 294 and may be tightened and loosened using dial 292 to adjust headband portion 282.

Lattice structures 284 and 294 may be formed from a molded polymer or other stiff material. Therefore, lattice structures 284 and 294 may allow headband portions 280 and 282 to support a head-mounted device on a head of a user. Additionally, the use of lattice structures 284 and 294 with openings 286 and 296 may allow headband portions 280 and 282 to be sufficiently conformable to the head of the user (e.g., due to the flexibility of the lattice structures about the openings).

In some embodiments, at least some of the lattice structures in headband portion 280 and/or headband portion 282 may be formed from a weighted material (e.g., a metal) and/or the gaps between the lattice structures may be filled with the weighted material. As an illustrative example, the weighted material may be added to one or both of the headband portions to provide a counterweight for a head-mounted device coupled to headband system 13.

Although not shown in FIG. 24A for clarity, headband portion 280 and/or headband portion 282 may be covered with fabric. In this way, the lattice structures of headband portions 280 and 282 may support a head-mounted device on the user's head, while headband portions 280 and 282 remain sufficiently comfortable for the user. Alternatively or additionally, one or more components, such as one or more removable batteries and/or one or more removable pads may be coupled to one or more of the headband portions.

Although FIG. 24A shows upper and lower headband portions of headband system 13 formed from lattice structures, this is merely illustrative. In general, one or more headband portions of headband system 13 may be formed from lattice structures.

Alternatively or additionally to forming one or more headband portions of headband system 13 from lattice structures, one or more of the headband portions may be formed from molded elliptical structures. An illustrative example is shown in FIG. 24B.

As shown in FIG. 24B, headband portion 281 (which may correspond to headband portion 280 or 282 of FIG. 24A) of headband system 13 may include molded elliptical structures 300 (also referred to as ribs 300 herein) (e.g., molded components). However, the user of molded elliptical structures is merely illustrative. In general, structures with any suitable shape(s) may be incorporated into headband portion 281.

Molded elliptical structures 300 may be formed from polymer or another suitable material, and molded elliptical structures 300 may surround openings 301. Cable 312 may be routed within molded elliptical structures 300 and may be tightened and loosened by dial 310 to tighten and loosen headband portion 281. However, this is merely illustrative. Cable 312 may be adjusted directly by a user, or cable 312 may be adjusted by any suitable adjustment mechanism.

Molded elliptical structures 300 may be aligned vertically along headband portion 281. Material 302 (e.g., a molded polymer, a resin, or another suitable material) may be formed over molded elliptical structures 300, including within openings 301.

Molded elliptical structures 300 may be formed from a molded polymer or other stiff material. Therefore, molded elliptical structures 300 may allow headband portion 281 to support a head-mounted device on a head of a user. Additionally, the use of molded elliptical structures 300 with openings 301 may allow headband portion 281 to be sufficiently conformable to the head of the user (e.g., due to the flexibility of the molded elliptical structures about the openings). For example, molded elliptical structures 300 may be flexible in directions 304 and 306, as well as rotationally flexible in direction 308. In this way, molded elliptical structures 300 may allow headband portion 281 to flex about a user's head.

In some embodiments, at least some of the molded elliptical structures in headband portion 281 may be formed from a weighted material (e.g., a metal, such as brass) and/or openings 301 may be filled with the weighted material. As an illustrative example, the weighted material may provide a counterweight for a head-mounted device coupled to headband system 13. Alternatively or additionally, at least some of the molded elliptical structures may be formed from springs (e.g., carbon fiber springs), or springs may otherwise be incorporated within headband portion 281.

Although not shown in FIG. 24B for clarity, headband portion 281 may be covered with fabric instead of or in addition to molded elliptical structures 300 being covered with material 302. The fabric may have a straight edge along a periphery of headband portion 281, or the fabric may be scalloped along the periphery of headband portion 281 (e.g., to prevent bunching of the fabric when headband portion 281 is bent). In this way, the molded elliptical structures of headband portion 281 may support a head-mounted device on the user's head, while headband portion 281 remain sufficiently comfortable for the user. Alternatively or additionally, one or more components, such as one or more removable batteries and/or one or more removable pads may be coupled to headband portion 281.

Although FIG. 24B shows a single headband portion 281 including molded elliptical structures 300, this is merely illustrative. In general, one or more headband portions of headband system 13 may include molded structures, such as molded elliptical structures 300.

Regardless of whether lattice structures (e.g., lattice structures 284 and 294 of FIG. 24A) and/or molded structures (e.g., molded elliptical structures 300 of FIG. 24B) are incorporated into a headband, the lattice structures and/or molded structures may be ribbed to allow additional flexibility. An illustrative example is shown in FIG. 24C.

Headband portion 281 may include lattice structures or molded structures, such as molded elliptical structures 300 of FIG. 24C, that include ribs 314. Ribs 314 may be a series of recesses (e.g., recesses formed during molding or removed after molding), which may provide molded elliptical structures 300 with enhanced flexibility to conform to the user's head.

Moreover, whether lattice structures or molded structures are incorporated into headband portion 281, headband portion 281 may be secured to itself using magnets. An illustrative example is shown in FIG. 24D.

As shown in FIG. 24D, headband portion 281 may include double backed portion 318 (e.g., a portion of the strap of headband portion 281 that doubles back about structure 316, which may be a loop, such as a metal or plastic loop). Headband portion 281 may include magnets (e.g., between or coupled to lattice structures or molded elliptical structures) that allow double backed portion 318 to attach to the main portion of headband portion 281 (e.g., by magnetically attracting double backed portion 318 in direction 319). In this way, headband portion 281 may be tightened and loosened about structure 316 and secured using the magnets within headband portion 281.

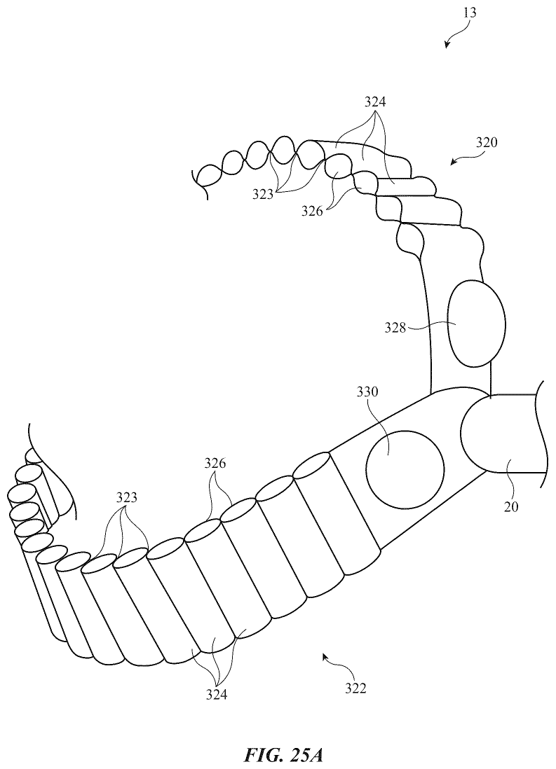

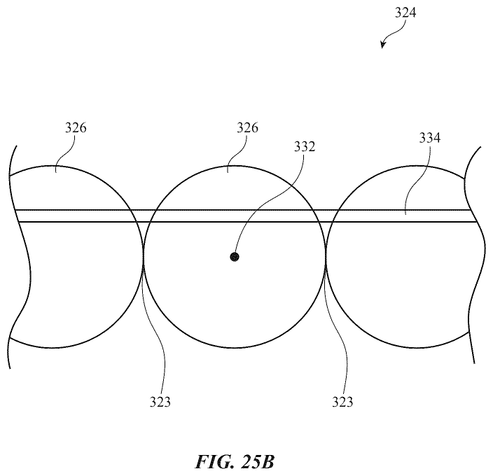

In some embodiments, one or more headband portions of headband system 13 may include accordion folds to increase the flexibility of the headband portion(s) and/or to allow components to be coupled to the headband portion(s). An illustrative example is shown in FIG. 25A.

As shown in FIG. 25A, headband system 13 may include headband portion 320 (which may correspond with headband portion 24 of FIG. 1) and headband portion 322 (which may correspond with headband portion 26 of FIG. 1). Headband portions 320 and 322 may be formed from fabric and may include accordion folds 324. Accordion folds 324 may include cinched portions 323 (e.g., sewn portions of headband portions 320 and 322) that leave sufficient loose fabric to form openings 326.

Openings 326 of accordion folds 324 may include headband portions 320 and 322 to stretch and contract to fit a user's head. Additionally or alternatively, openings 326 of accordion folds 324 may be filled with suitable components, such as batteries (e.g., removable batteries connected to a head-mounted device coupled to headband system 13) and/or weights (e.g., metal counterweights). In this way, accordion folds 324 may improve the flexibility of headband portions 320 and 322 and/or provide additional functionality to headband portions 320 and 322.

Each headband portion 320 and 322 may include at least 15, at least 20, at least 30, or at least 40 accordion folds 324, as examples. Accordion folds 324 may have widths of at least 4 mm, less than 15 mm, or at least 6 mm, as examples.

Cables coupled to dials 328 and 330 may be tightened and loosened by rotating dials 328 and 330 to tighten and loosen headband portions 320 and 322, respectively. The cables may pass through accordion folds 324. An illustrative example is shown in FIG. 25B.

As shown in FIG. 25B, accordion folds 324 may define openings 326 with centers 332. Cable 334, which may be coupled to dial 328 or 330 of FIG. 25A, may pass through accordion folds 324 and may be offset from centers 332. Dial 328 or dial 330 may be tightened or loosened to adjust the headband portion.

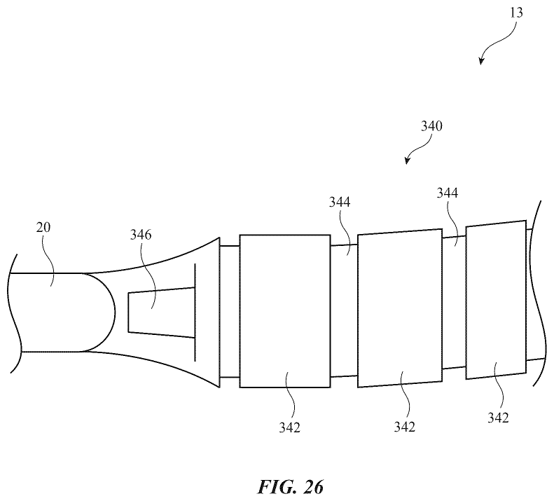

Although FIG. 25A shows accordion folds 324 on headband portions 320 and 322, this is merely illustrative. In general, accordion folds may be incorporated into one or more headband portions of headband system 13. In some embodiments, headband system 13 may include a headband portion that is formed from removable links. An illustrative example is shown in FIG. 26.

As shown in FIG. 26, headband system 13 may include headband portion 340 with links 342. Headband portion 340 may correspond with headband portion 24 or headband portion 26 of FIG. 1, and/or headband system 13 may have a single headband portion 340. Links 342 may be formed from plastic, metal, polymer, and/or other suitable materials. In some embodiments, links 342 may be rigid or stiff components. However, links 342 may be at least partially flexible or compliant, if desired.

Links 342 may be coupled by material 344. Material 344 may be a polymer, an elastomer, or another suitable material. In general, material 344 may allow links 342 to move relative to one another and allow headband portion 340 to bend to match a curvature of the user's head.

Links 342 may be removable links (and may sometimes be referred to as removable links 342 herein). Links 342 may be added or removed to allow for an individual fit for a user of headband system 13. Additionally or alternatively, tab 346 may allow for tightening and loosening of headband portion 340.

If desired, at least some of links 342 may be removed and replaced with other components. For example, a removable battery may replace at least some of links 342 in headband portion 340 and may provide power to a head-mounted device.

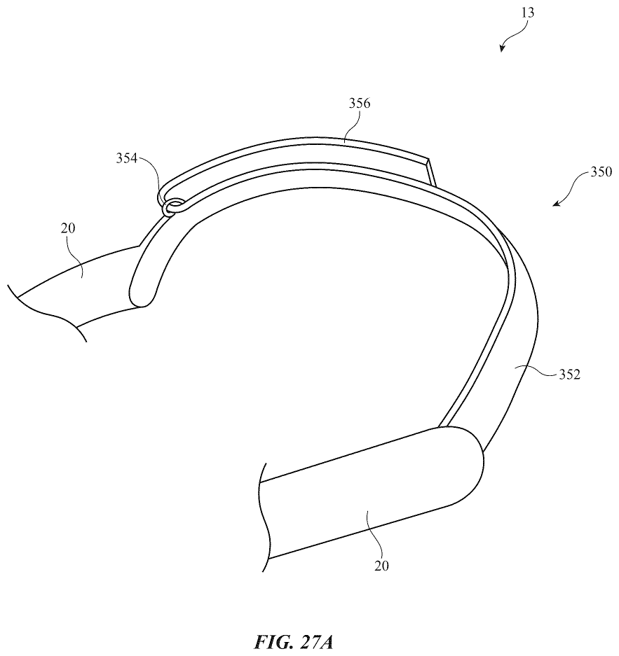

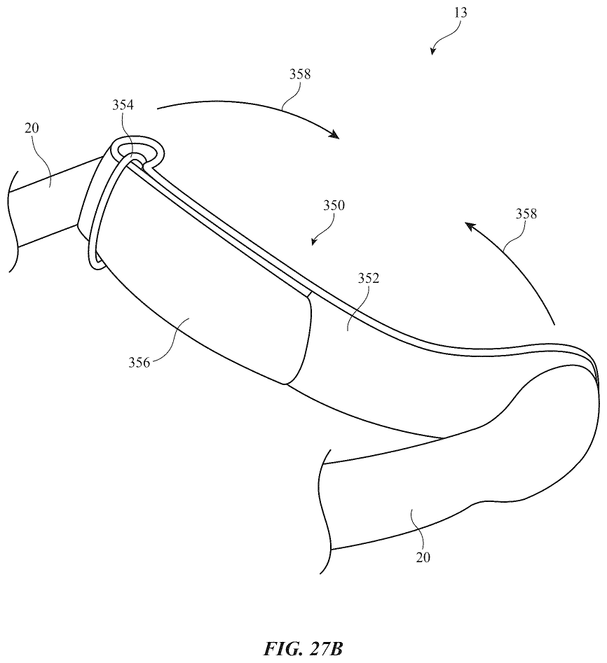

In some embodiments, headband system 13 may include a headband portion that can telescope and fold to stow. An illustrative example is shown in FIG. 27A.

As shown in FIG. 27A, headband system 13 may include headband portion 350 coupled to extension 20 (e.g., an extension of a head-mounted device). Headband portion 350 may include strap 352. Strap 352 may be formed from fabric, such as a woven or knit fabric. Strap 352 may be wrapped around loop 354 (e.g., a metal loop or a plastic loop) to form double backed portion 356. Double backed portion 356 may then be attached to the main (opposing portion) of strap 352, such as using magnets (e.g., magnets embedded in strap 352), hook and loop fasteners, and/or other suitable attachments. The fitment of headband portion 350 may be adjusted by adjusting the length of double backed portion 356.

Additionally, headband portion 350 may be rotated and folded to stow headband portion 350. An illustrative example is shown in FIG. 27B.

As shown in FIG. 27B, headband portion 350 may rotate relative to extension 20. Additionally, extensions 20 may be moved in directions 358 to fully stow headband portion 350 relative to a head-mounted device to which headband system 13 is attached. In this way, headband portion 350 may be adjustable and stowable.

Although not shown in FIGS. 27A and 27B, a removable battery may be attached to headband portion 350, if desired.

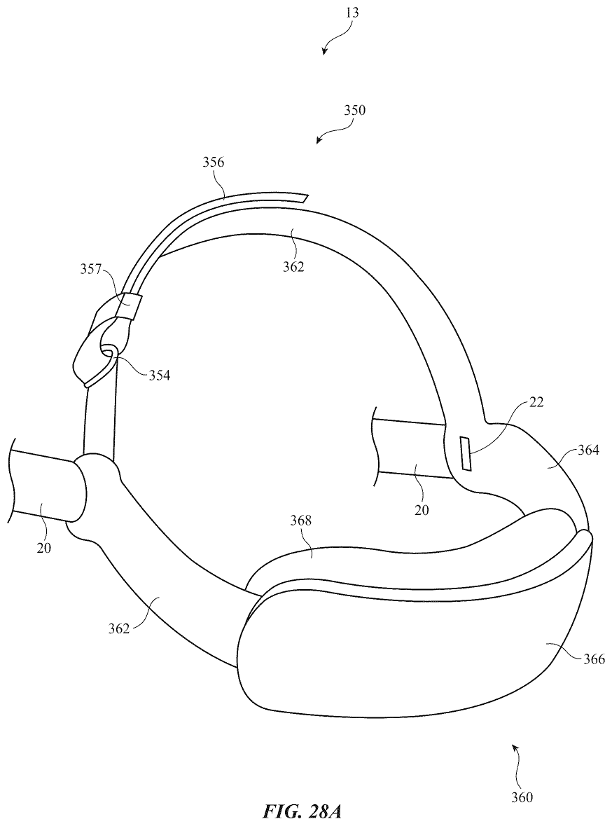

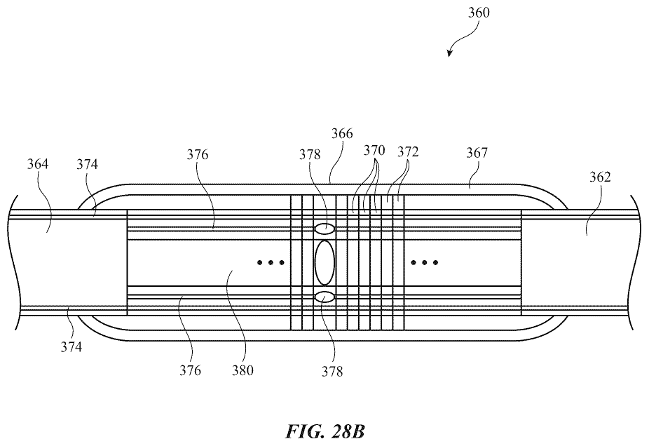

In some embodiments, headband system 13 may include a portion with vertical ribs. An illustrative example is shown in FIGS. 28A and 28B.

As shown in FIG. 28A, headband system 13 may include headband portions 350 and 360, which may correspond to headband portions 24 and 26 of FIG. 1, respectively. Headband portion 350 may have strap 352 and double backed portion 356 about loop 354, similar to in FIGS. 27A and 27B. Soft loop 357 may retain double backed portion 356 against strap 352, if desired.

Headband portion 360 may include strap 362 and strap 364, each coupled to an extension 20 at connection 22. Straps 362 and 364 may be formed from fabric, polymer, and/or other suitable materials. Structure 366 may be a rigid or semi-flexible support structure in which straps 362 and 364 terminate. Cushion 368, formed from foam and/or other compliant material, may be coupled to structure 366. Cushion 368 may be configured to contact a rear of a user's head when headband system 13 is worn by the user.

Structure 366 may include vertical ribs that support headband portion 360, while retaining some flexibility of structure 366, if desired. As shown in FIG. 28B, for example, structure 366 may include outer housing 367, which may be formed from plastic or metal, as examples. Ribs 370 may extend vertically across structure 366. Ribs 370 may be formed from a metal, such as stainless steel or aluminum, plastic, and/or other suitable materials. Ribs 370 may be coupled to spine 372. Spine 372 may couple ribs 370 together, while allowing bending between ribs 370 to allow headband portion 360 to conform to the user's head. Spine 372 may be formed from a metal, such as steel, plastic, and/or other suitable materials.

Straps 364 and 362 may be coupled to one another with elastic 380. Cables 374 may extend through structure 366 and be coupled to dials or other adjustment mechanisms to tighten and loosen headband portion 360. Cables 376 (e.g., additional cables) may be coupled between the strips and portions 378 of structure 366 to provide a hard stop for straps 364 and 362 (e.g., to ensure that straps 364 and 362 are not loosened too much). In this way, structure 366 may house the ends of straps 364 and 362, ribs 370 that allow structure 366 to flex, cables 374 that allow adjustments of headband portion 360, and hard stop structures.

If desired, a battery, such as a removable battery, may be coupled to structure 366. In the example of FIG. 28A, the battery may be attached (e.g., magnetically, using clips, or otherwise attached) to a rear face of structure 366, opposite cushion 368. The battery may then be electrically coupled to a head-mounted device to which headband system 13 is attached to provide power to the head-mounted device.

Multiple headband portions with different adjustment mechanisms, headband materials, connectors, counterweights, removable batteries, and cantilevers have been described in connection with FIGS. 1-28B. In general, any desired headband portion of any desired headband system (e.g., a headband system 13) may include one or more of these adjustment mechanisms, headband materials, connectors, counterweights, removable batteries, and/or cantilevers to support a head-mounted device on a user's head while remaining comfortable for the user.

To help protect the privacy of users, any personal user information that is gathered by device 10 may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. A headband system configured to be coupled to a head-mounted device comprising a head-mounted housing and to be worn on a head, the headband system comprising:
a first headband portion; and
a second headband portion, wherein the second headband portion comprises:
a first portion,
a second portion, and
an adjuster configured to move the first portion and the second portion symmetrically to adjust a tension of the second headband portion.

2. The headband system of claim 1, wherein the adjuster comprises a symmetric telescoping cable and wherein the first portion comprises:
an adjustment dial; and
a tension cable coupled to the adjustment dial and to the first portion, wherein the adjustment dial is configured to be rotated to move the first portion, and the adjuster is configured to move the second portion symmetrically as the first portion is moved.

3. The headband system of claim 2, wherein the second headband portion further comprises a support between the first portion and the second portion, and the first portion further comprises:
stretchable material between an end of the tension cable and the support, wherein the stretchable material is configured to expand when the headband system is removed from the head and to maintain the tension of the second headband portion when the headband system is returned to the head.

4. The headband system of claim 1, wherein the adjuster comprises a symmetric telescoping cable and wherein the first portion further comprises:
an adjustment dial; and
a cable that extends from the adjustment dial to the second portion, wherein the adjustment dial is configured to be rotated to move the second portion, and the adjuster is configured to move the first portion symmetrically as the second portion is moved.

5. The headband system of claim 4, wherein the first portion further includes a first spring, the second portion further includes a second spring, and the first and second springs are configured to bias the first and second portions towards one another.

6. The headband system of claim 1, wherein the adjuster comprises a symmetric telescoping cable, the adjuster further comprises a motor coupled to the symmetric telescoping cable, the motor is configured to move the symmetric telescoping cable to move the first portion and the second portion, and the motor is configured to release the tension of the second headband portion in response to a detected movement of the head-mounted device being pulled away from the head.

7. The headband system of claim 1, wherein the adjuster comprises a turnbuckle between the first and second portions.

8. The headband system of claim 1, wherein the adjuster comprises spur gears and lead screws between the first and second portions.

9. The headband system of claim 1, wherein the adjuster comprises a rack and pinion system between the first and second portions.

10. The headband system of claim 1, further comprising:
a support that partially overlaps the first portion and the second portion, wherein the support is configured to overlap the first portion by a first distance, a distance between the first portion and the second portion at a maximum extension is a second distance, and a ratio of the second distance to the first distance is 3:1 or less.

11. The headband system of claim 1, further comprising:
a removable weighted component coupled to the second headband portion.

12. The headband system of claim 11, wherein the removable weighted component comprises a removable battery.

13. The headband system of claim 12, wherein the second headband portion further comprises:
a component between the first portion and the second portion, wherein the component comprises a battery, and the removable battery is configured to charge the battery when the removable weighted component is coupled to the second headband portion.

14. The headband system of claim 11, wherein the removable weighted component comprises a removable weight, the removable weight comprises a weighted bean bag, and the removable weight is interposed between the second headband portion and the head when the headband system is worn.

15. A headband system configured to be coupled to a head-mounted device comprising a head-mounted housing and to be worn on a head, the headband system comprising:
a first telescoping tube; and
a second telescoping tube, wherein the first and second telescoping tubes are configured to be tightened and loosened to adjust a tension of the headband system.

16. The headband system of claim 15, wherein the headband system further comprises:
an upper headband portion, wherein the first telescoping tube and the second telescoping tube are formed in the upper headband portion; and
a lower rear headband portion.

17. The headband system of claim 16, wherein the first telescoping tube comprises an inner tube, an outer tube, and a cable within the inner tube, and the cable is configured to tighten and loosen the first telescoping tube.

18. The headband system of claim 16, wherein the upper headband portion further includes:
a pad, wherein the first and second telescoping tubes are routed through openings in the pad, and the pad is interposed between the first and second telescoping tubes and the head when the headband system is worn.

19. The headband system of claim 15, wherein the headband system further comprises:
an upper headband portion; and
a lower rear headband portion, wherein the first telescoping tube and the second telescoping tube are formed in the lower rear headband portion.

20. The headband system of claim 19, wherein the lower rear headband portion further includes:
a pad, wherein the first and second telescoping tubes are routed through openings in the pad, the pad is interposed between the first and second telescoping tubes and the head when the headband system is worn, and the pad includes a central opening.

21. The headband system of claim 19, wherein the first telescoping tube is configured to rest against an upper portion of a rear of the head and the second telescoping tube is configured to rest against a lower portion of the rear of the head when the headband system is worn.

22. The headband system of claim 21, further comprising:
an enclosure, wherein the first and second telescoping tubes are routed through openings in the enclosure; and
a battery embedded in the enclosure.

23. A headband system configured to be coupled to a head-mounted device comprising a head-mounted housing and to be worn on a head, the headband system comprising:
a first headband portion; and
a second headband portion, wherein the second headband portion comprises:
a first strap coupled to the head-mounted housing,
a second strap coupled to the head-mounted housing,
a structure interposed between the first strap and the second strap, wherein ends of the first strap and the second strap extend into the structure, and the structure comprises:
a plurality of ribs coupled to a spine,
adjustment cables that extend from the first strap to the second strap through the structure, and
elastic coupled to between the ends of the first strap and the second strap.

24. The headband system of claim 23, wherein the structure further comprises additional cables between the first strap and the second strap, and the additional cables are configured to provide a hard stop for the first strap and the second strap.

25. The headband system of claim 24, wherein the structure comprises a first surface configured to face the head and an opposing second surface, and the headband system further comprises:
a cushion on the first surface.

26. The headband system of claim 25, further comprising:
a battery removably coupled to the second surface.

27. The headband system of claim 26, wherein the battery is configured to be magnetically attached to the structure at the second surface.
